(19) United States
(12) Patent Application Publication
(10) Pub. No.: US 2026/0172586 A1
(43) Pub. Date: Jun. 18, 2026

(54) VIDEO ENCODING AND DECODING METHODS AND APPARATUSES, COMPUTER-READABLE MEDIUM, AND ELECTRONIC DEVICE

(71) Applicant: Tencent Technology (Shenzhen) Company Limited, Shenzhen (CN)

(72) Inventor: Yingbin WANG, Shenzhen (CN)

(21) Appl. No.: 19/462,825

(22) Filed: Jan. 28, 2026

Related U.S. Application Data
(63) Continuation of application No. PCT/CN2024/109645, filed on Aug. 2, 2024.

(30) Foreign Application Priority Data
Aug. 20, 2023 (CN) 202311051402.X

(51) Int. Cl. H04N 19/44; H04N 19/105; H04N 19/176

(52) U.S. Cl. CPC H04N 19/44; H04N 19/105; H04N 19/176

(57) ABSTRACT

This application provides a video decoding method performed by an electronic device. The method includes: decoding a video bitstream to obtain bitstream information; determining a reference weight derivation function used by a coded block according to the bitstream information; calculating a reference weight corresponding to the coded block according to the reference weight derivation function; determining, according to the reference weight, a weight matrix corresponding to the coded block; and performing weighted prediction according to the weight matrix, to obtain a predicted value corresponding to the coded block. The technical solutions in the embodiments of this application are provided, whereby a reference weight derivation function may be adaptively selected for a coding block and indicated by bitstream information. Therefore, a more accurate weight matrix may be derived for different coding blocks, to help improve encoding/decoding performance.

### CROSS-REFERENCE TO RELATED APPLICATIONS

This application is a continuation application of PCT Patent Application No. PCT/CN2024/109645, entitled “VIDEO ENCODING AND DECODING METHODS AND APPARATUSES, COMPUTER-READABLE MEDIUM, AND ELECTRONIC DEVICE” filed on Aug. 2, 2024, which claims priority to Chinese Patent Application No. 202311051402.X, entitled “VIDEO ENCODING AND DECODING METHODS AND APPARATUSES, COMPUTER-READABLE MEDIUM, AND ELECTRONIC DEVICE” filed with the China National Intellectual Property Administration on Aug. 20, 2023, both of which are incorporated by reference in their entirety.

### FIELD OF THE TECHNOLOGY

This application relates to the field of computer and communication technologies, and in particular to video encoding and decoding methods and apparatuses, a computer-readable medium, and an electronic device.

### BACKGROUND OF THE DISCLOSURE

In relevant audio and video standards (such as the second stage of the third generation of Audio Video Coding Standard (AVS3)), the angular weighted prediction (AWP) technology and the spatial angular weighted prediction (SAWP) technology are adopted. These prediction technologies use a weight mask to perform weighting on two prediction blocks, to combine different parts of the prediction blocks. These prediction technologies can be closer to boundaries of different objects or boundaries of different motion areas than block partitioning, and therefore, can effectively improve compression performance. To smoothly change a pixel value at a combined boundary of a prediction block, a weight matrix of these prediction technologies has a transition zone (namely, a blending area) near a division boundary. In the related art, a weight in the transition zone is derived according to a fixed linear function. However, the fixed linear function cannot adapt to all coding blocks, which affects improvement of coding performance to an extent.

### SUMMARY

Embodiments of this application provide video encoding and decoding methods and apparatuses, a computer-readable medium, and an electronic device, whereby a reference weight derivation function may be adaptively selected for a coding block and indicated by bitstream information. Therefore, a more accurate weight matrix may be derived for different coding blocks, to help improve encoding/decoding performance.

Other characteristics and advantages of this application become apparent through the following detailed descriptions, or may be partially learned through the practice of this application.

In an aspect, the embodiments of this application provide a video decoding method, which includes: decoding a video bitstream to obtain bitstream information; determining a reference weight derivation function used by a coded block according to the bitstream information; calculating a reference weight corresponding to the coded block according to the reference weight derivation function; determining, according to the reference weight, a weight matrix corresponding to the coded block; and performing weighted prediction according to the weight matrix, to obtain a predicted value corresponding to the coded block.

In an aspect, the embodiments of this application provide a video encoding method, which includes: determining a reference weight derivation function used by a to-be-encoded block adopting a weighted prediction mode; calculating a reference weight corresponding to the to-be-encoded block by using the reference weight derivation function; determining, according to the reference weight, a weight matrix corresponding to the to-be-encoded block; and performing weighted prediction according to the weight matrix, to obtain a predicted value corresponding to the to-be-encoded block, and encoding the to-be-encoded block according to the predicted value.

In an aspect, the embodiments of this application provide a video decoding apparatus, which includes: a decoding unit, configured to decode a video bitstream, and determine, according to bitstream information obtained through decoding, a reference weight derivation function used by a coding block adopting a weighted prediction mode; a calculation unit, configured to calculate a reference weight corresponding to the coding block by using the reference weight derivation function; a determination unit, configured to determine, according to the reference weight, a weight matrix corresponding to the coding block; and a processing unit, configured to perform weighted prediction according to the weight matrix, to obtain a predicted value corresponding to the coding block.

In an aspect, the embodiments of this application provide a video encoding apparatus, which includes: a processing unit, configured to determine a reference weight derivation function used by a to-be-encoded block adopting a weighted prediction mode; a calculation unit, configured to calculate a reference weight corresponding to the to-be-encoded block by using the reference weight derivation function; a determination unit, configured to determine, according to the reference weight, a weight matrix corresponding to the to-be-encoded block; and an encoding unit, configured to perform weighted prediction according to the weight matrix, to obtain a predicted value corresponding to the to-be-encoded block, and encode the to-be-encoded block according to the predicted value.

In an aspect, the embodiments of this application provide a non-transitory computer-readable medium, which has a computer program stored therein. A processor of an e electronic device, when executing the computer program, causes the electronic device to implement the method as described in the foregoing embodiments.

In an aspect, the embodiments of this application provide an electronic device, which includes: one or more processors; and a storage apparatus, configured to store one or more programs, the one or more processor executing the one or more programs, to cause the electronic device to implement the method as described in the foregoing embodiments.

In an aspect, the embodiments of this application provide a computer program product, which includes a computer program. The computer program is stored in a computer-readable storage medium. A processor of an electronic device reads the computer program from the computer-readable storage medium and executes the computer program, to cause the electronic device to perform the method provided in the foregoing embodiments.

In the technical solutions provided in some embodiments of this application, the reference weight derivation function used by the coding block adopting the weighted prediction mode is determined according to the bitstream information obtained through decoding, then the reference weight corresponding to the coding block is calculated by using the reference weight derivation function, the weight matrix corresponding to the coding block is determined according to the reference weight, and weighted prediction is performed according to the determined weight matrix, to obtain the predicted value corresponding to the coding block, whereby the reference weight derivation function may be adaptively selected for the coding block and indicated by the bitstream information. Therefore, a more accurate weight matrix may be derived for different coding blocks, to help improve encoding/decoding performance.

The foregoing general descriptions and the following detailed descriptions are merely for illustration and explanation purposes and are not intended to limit this application.

### BRIEF DESCRIPTION OF THE DRAWINGS

FIG. 1 is a schematic diagram of an exemplary system architecture to which technical solutions in embodiments of this application may be applied.

FIG. 2 is a schematic diagram of a placement mode of a video encoding apparatus and a video decoding apparatus in a streaming transmission system.

FIG. 3 is a basic flowchart of a video encoder.

FIG. 4 is a schematic diagram of a block partitioning structure in the High Efficiency Video Coding (HEVC) standard.

FIG. 5 is a schematic diagram of a block partitioning structure in the third generation of Audio Video Coding Standard (AVS3).

FIG. 6 is a schematic diagram of an angle prediction direction in an intraframe prediction mode.

FIG. 7 is a schematic diagram of intraframe prediction.

FIG. 8 is a schematic diagram of interframe prediction.

FIG. 9 is a schematic diagram of a prediction process of an angular weighted prediction (AWP) mode.

FIG. 10 is a diagram of eight weight generation angles.

FIG. 11 is a schematic diagram of seven reference weight prediction positions.

FIG. 12 is a schematic diagram of angle areas in an AWP mode.

FIG. 13 is a flowchart of a video decoding method according to an embodiment of this application.

FIG. 14 is a flowchart of a video encoding method according to an embodiment of this application.

FIG. 15 is a schematic diagram of a picture of a reference weight derivation function in the form of a sigmoid function according to an embodiment of this application.

FIG. 16 is a schematic diagram of a picture of a reference weight derivation function based on a hyperbolic tangent function according to an embodiment of this application.

FIG. 17 is a schematic diagram of a picture of a reference weight derivation function based on a cosine function according to an embodiment of this application.

FIG. 18 is a block diagram of a video decoding apparatus according to an embodiment of this application.

FIG. 19 is a block diagram of a video encoding apparatus according to an embodiment of this application.

FIG. 20 is a schematic structural diagram of a computer system adapted to implement an electronic device according to an embodiment of this application.

### DESCRIPTION OF EMBODIMENTS

Exemplary implementations are now described in a more comprehensive manner with reference to the accompanying drawings. However, the exemplary implementations may be implemented in various forms, and are not to be understood as being limited to these examples. On the contrary, the purpose of providing the implementations is to make this application more comprehensive and complete, and to fully convey the concept of the exemplary implementations to those skilled in the art.

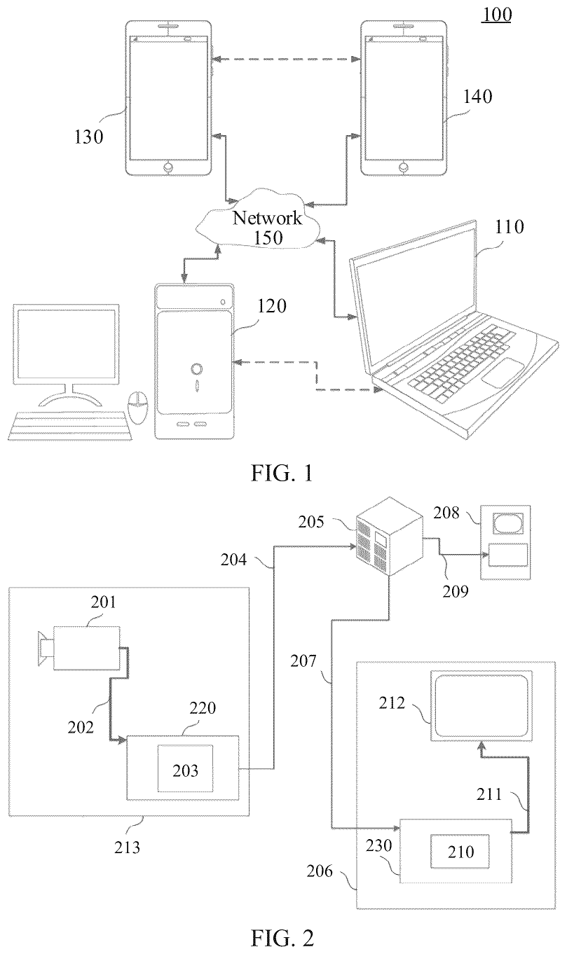

FIG. 1 is a schematic diagram of an exemplary system architecture to which technical solutions in embodiments of this application may be applied. As shown in FIG. 1, a system architecture 100 includes a plurality of terminal apparatuses. The terminal apparatuses may communicate with each other, for example, over a network 150. For example, the system architecture 100 may include a first terminal apparatus 110 and a second terminal apparatus 120 that are connected to each other through the network 150. In the embodiment shown in FIG. 1, the first terminal apparatus 110 and the second terminal apparatus 120 perform unidirectional data transmission.

For example, the first terminal apparatus 110 may encode video data (such as a video picture stream collected by the terminal apparatus 110) and transmit the encoded video data to the second terminal apparatus 120 over the network 150. The encoded video data is transmitted in the form of one or more encoded video bitstreams. The second terminal apparatus 120 may receive the encoded video data over the network 150, decode the encoded video data to restore the video data, and display video pictures according to the restored video data.

In an embodiment of this application, the system architecture 100 may include a third terminal apparatus 130 and a fourth terminal apparatus 140 that perform bidirectional transmission on encoded video data. The bidirectional transmission may occur, for example, during a video meeting. For bidirectional data transmission, one of the third terminal apparatus 130 and the fourth terminal apparatus 140 may encode video data (such as a video picture stream collected by the terminal apparatus) and transmit the encoded video data to the other one of the third terminal apparatus 130 and the fourth terminal apparatus 140 over the network 150. One of the third terminal apparatus 130 and the fourth terminal apparatus 140 may further receive the encoded video data transmitted by the other one of the third terminal apparatus 130 and the fourth terminal apparatus 140, decode the encoded video data to restore the video data, and display video pictures on an accessible display apparatus according to the restored video data.

In the embodiment shown in FIG. 1, the first terminal apparatus 110, the second terminal apparatus 120, the third terminal apparatus 130, and the fourth terminal apparatus 140 may be servers or terminals, but the principles disclosed in this application may not be limited thereto. The server may be an independent physical server, a server cluster or distributed system that includes a plurality of physical servers, or a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. The terminal may be a smartphone, a tablet computer, a notebook computer, a desktop computer, a smart speaker, an intelligent voice interaction device, a smartwatch, a smart home appliance, an on-board terminal, an aerial vehicle, or the like, but is not limited thereto.

The network 150 shown in FIG. 1 represents any number of networks configured for transmitting encoded video data between the first terminal apparatus 110, the second terminal apparatus 120, the third terminal apparatus 130, and the fourth terminal apparatus 140, which include, for example, wired and/or wireless communication networks. The communication network 150 may be configured for exchanging data in circuit-switched and/or packet-switched channels. The network may include telecommunications networks, local area networks, wide area networks and/or the Internet. For the purpose of this application, unless explained below, an architecture and topology of the network 150 may be immaterial to operations disclosed in this application.

In an embodiment of this application, FIG. 2 is a schematic diagram of a placement mode of a video encoding apparatus and a video decoding apparatus in a streaming transmission environment. The subject matter disclosed in this application may be equally applicable to other video-enabled applications, including, for example, video meeting, a digital television (TV), and storage of compressed video on digital media including compact discs (CDs), digital video discs (DVDs), memory sticks, and the like.

A streaming transmission system may include a collection subsystem 213. The collection subsystem 213 may include a video source 201 such as a digital camera. The video source 201 creates an uncompressed video picture stream 202. In the embodiments, the video picture stream 202 includes a sample taken by the digital camera. The video picture stream 202 is depicted as a bold line to emphasize the video picture stream with a high data volume when compared to encoded video data 204 (or an encoded video bitstream 204). The video picture stream 202 may be processed by an electronic apparatus 220. The electronic apparatus 220 includes a video encoding apparatus 203 coupled to the video source 201. The video encoding apparatus 203 may include hardware, software, or a combination of software and hardware, to implement or perform each aspect of the disclosed subject matter described in more detail below. The encoded video data 204 (or the encoded video bitstream 204) is depicted as a thin line to emphasize the encoded video data 204 (or the encoded video bitstream 204) with a low data volume when compared to the video picture stream 202, which may be stored on a streaming transmission server 205 for future use. One or more streaming transmission client subsystems, such as a client subsystem 206 and a client subsystem 208 in FIG. 2, may access the streaming transmission server 205 to retrieve a copy 207 and a copy 209 of the encoded video data 204. The client subsystem 206 may include, for example, a video decoding apparatus 210 in an electronic apparatus 230. The video decoding apparatus 210 decodes the input copy 207 of the encoded video data, and generates an output video picture stream 211 that may be displayed on a display 212 (such as a display screen) or another display apparatus. In some streaming transmission systems, the encoded video data 204, video data 207, and video data 209 (such as video bitstreams) may be encoded according to video coding/compression standards.

The electronic apparatus 220 and the electronic apparatus 230 may include other components not shown. For example, the electronic apparatus 220 may include a video decoding apparatus, and the electronic apparatus 230 may further include a video encoding apparatus.

In an embodiment of this application, international video coding standards, such as High Efficiency Video Coding (HEVC) and Versatile Video Coding (VVC), and the Chinese national video coding/encoding standards, such as Audio Video Coding Standard (AVS), are taken as examples, after being inputted, a video frame picture is partitioned into a plurality of non-overlapping processing units according to a block size, and a similar compression operation is performed on each processing unit. The processing unit is referred to as a coding tree unit (CTU) or a largest coding unit (LCU). The CTU may be further partitioned into one or more basic coding units (CU). The CU is the most basic element in a coding process.

In another embodiment, the processing unit may also be referred to as a tile, which is a rectangular area of a multimedia data frame that may be independently decoded and coded. In the Alliance for Open Media Video 1 (AV1) standard, the tile may be further partitioned into one or more superblocks (SB). The SB is a starting point of block partitioning and may be further partitioned into a plurality of sub-blocks. Then, the superblock may be further partitioned into one or more blocks. Each block is the most basic element in a coding process. In an embodiment, one SB may include a plurality of blocks.

The foregoing partitioning mode of the video frame picture may be referred to as a block partition structure. Some concepts in the coding process are described below:

Predictive coding: the predictive coding includes modes such as intraframe prediction and interframe prediction. After an original video signal is predicted based on a selected reconstructed video signal, a residual video signal is obtained. An encoding end needs to select a predictive coding mode for a current CU (or coding block) and inform a decoding end of the predictive coding mode. The intraframe prediction refers to that a predicted signal comes from an area that has been encoded and reconstructed in a same picture. The interframe prediction refers to that a predicted signal comes from an encoded picture (referred to as a reference picture) that is different from a current picture.

Transform & quantization: a transform operation, such as discrete Fourier transform (DFT) or discrete cosine transform (DCT), is performed on a residual video signal to convert the signal into a transform domain, which is referred to as a transform coefficient. A lossy quantization operation is further performed on the transform coefficient, which loses a specific amount of information, whereby the quantized signal is conductive to compressed expression. In some video coding standards, more than one transform mode may be selected. Therefore, the encoding end also needs to select one transform mode for the current CU (or coding block) and inform the decoding end of the transform mode. Precision of quantization is typically determined by a quantization parameter (QP). A larger value of the QP indicates that coefficients within a larger value range will be quantized into a same output, which usually results in greater distortion and a lower bit rate. On the contrary, a smaller value of the QP indicates that coefficients within a smaller value range will be quantized into a same output, which usually results in less distortion and a higher bit rate.

Entropy coding or statistical coding: statistical compression coding is performed on the quantized transform domain signal according to a frequency of occurrence of each value, and finally a binary (0 or 1) compressed bitstream is outputted. In addition, entropy coding also needs to be performed on other information generated through coding, such as a selected coding mode and motion vector data, to reduce the bit rate. Statistical coding is a lossless coding mode that can effectively reduce a bit rate required to express a same signal. A common statistical coding mode includes variable length coding (VLC) or context adaptive binary arithmetic coding (CABAC).

A process of CABAC mainly includes 3 operations: binarization, context modeling, and binary arithmetic coding. After an inputted syntactic element is binarized, binary data may be encoded in a normal coding mode and a bypass coding mode. In the bypass coding mode, a specific probability model does not need to be assigned to each binary bit, and an inputted binary bit bin value is directly encoded by adopting a simple bypass encoder to speed up the entire encoding and decoding process. In general, different syntax elements are not entirely independent of each other, and a same syntax element has a memory property. Therefore, according to a conditional entropy theory, conditional coding performed based on other encoded syntactic elements can further improve the coding performance compared to independent coding or memoryless coding. Such encoded symbolic information serving as a condition is referred to as a context. In a regular coding mode, binary bits of a syntax element are sequentially inputted into a context modeler. The encoder assigns an appropriate probability model for each inputted binary bit according to a value of a previously encoded syntax element or binary bit. This process is referred to as context modeling. A context model corresponding to a syntax element may be located based on a context index increment (ctxIdxInc) and a context index start (ctxIdxStart). After the bin value and the assigned probability model are inputted together into a binary arithmetic encoder for coding, the context model needs to be updated according to the bin value. This is an adaptive process during coding.

Loop filtering: operations, such as inverse quantization, inverse transform, and predictive compensation, are performed on a transformed and quantized signal to obtain a reconstructed picture. The reconstructed picture has some information different from that in an original picture as a result of quantization, that is, the reconstructed picture may cause distortion. Therefore, the reconstructed picture may be filtered by using a filter such as a deblocking filter (DB), a sample adaptive offset (SAO) filter, or an adaptive loop filter (ALF), which can effectively reduce a degree of distortion caused by quantization. Since the filtered reconstructed pictures will be taken as a reference for subsequently encoded pictures to predict future picture signals, filtering is also referred to as loop filtering, namely, filtering in a coding loop.

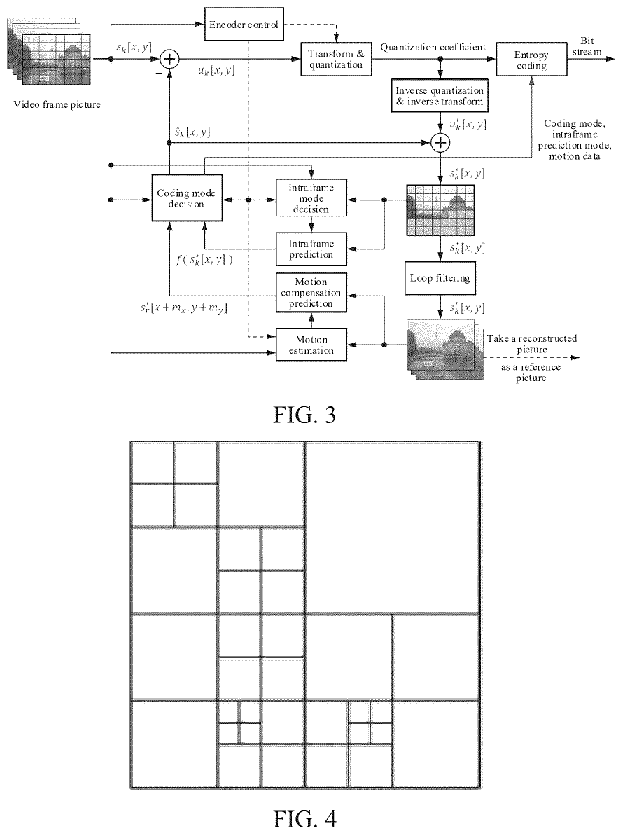

In an embodiment of this application, FIG. 3 is a basic flowchart of a video encoder. In this process, intraframe prediction is taken as an example for description. A difference between an original picture signal sₖ[x, y] and a predicted picture signal ŝₖ[x, y] is calculated to obtain a residual signal uₖ[x, y], and the residual signal uₖ[x, y] is transformed and quantized to obtain a quantization coefficient. The quantization coefficient is subjected to entropy coding to obtain an encoded bitstream, and is further subjected to inverse quantization and inverse transform to obtain a reconstructed residual signal u′ₖ[x, y]. The predicted picture signal ŝₖ[x, y] is superimposed with the reconstructed residual signal u′ₖ[x, y] to generate a picture signal

$${s}_{k}^{*} [ x , y ] .$$

The picture signal

$${s}_{k}^{*} [ x , y ]$$

is inputted to an intraframe mode decision module and an intraframe prediction module for intraframe prediction, and is further subjected to loop filtering to output a reconstructed picture signal s′ₖ[x, y]. The reconstructed picture signal s′ₖ[x, y] may be taken as a reference picture for a next frame for motion estimation and motion compensation prediction. Then, a predicted picture signal ŝₖ[x, y] of the next frame is obtained based on a motion compensation prediction result s′ᵣ[x+mₓ, y+m_{y}] and an intraframe prediction result

$$f ( {s}_{k}^{*} [ x , y ] ) .$$

The foregoing process is repeated until coding is completed.

Based on the foregoing coding process, at a decoding end, for each CU (or coding block), after a compressed bitstream (namely, bit stream) is acquired, entropy decoding is performed to obtain various mode information and a quantization coefficient. Then, inverse quantization and inverse transform are performed on the quantization coefficient to obtain a residual signal. Moreover, a predicted signal corresponding to the CU (or coding block) may be obtained according to coding mode information that is known. The residual signal may be added to the predicted signal to obtain a reconstructed signal. The reconstructed signal is subjected to operations such as loop filtering to generate a final output signal.

Currently, mainstream video coding standards, such as HEVC, VVC, AVS3, AV1, and AV2, all adopt a block-based hybrid coding framework. Specifically, original video data may be partitioned into a series of coding blocks, and video data compression may be implemented by a video coding method integrating prediction, transform, and entropy coding.

In the hybrid coding framework based on block partitioning, a video picture is partitioned into several non-overlapping processing units for video compression, and the processing unit is referred to as a CTU. The CTU may be further partitioned to obtain one or more basic coding units that are referred to as CUs. Each CU is the most basic element in a coding process, and different coding modes may be selected for each CU. As shown in FIG. 4, FIG. 4 is a schematic diagram of a block partitioning structure in the HEVC standard. One CTU may be partitioned downwards in a quadtree (QT) manner.

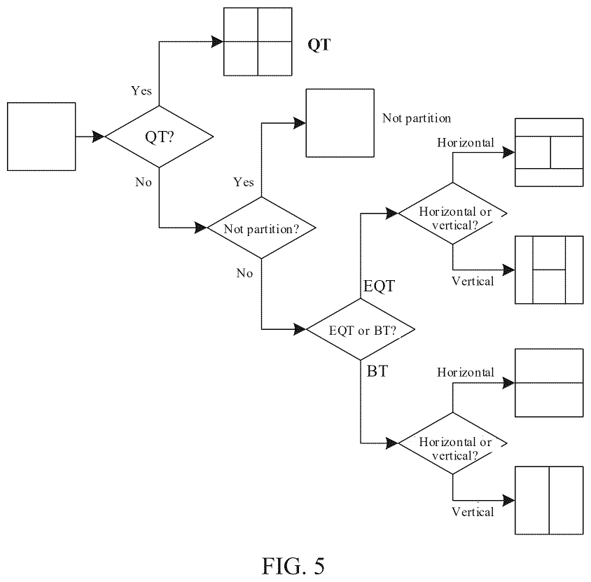

In the AVS3 standard, a basic block partitioning structure of QT+binary-tree (BT)+extended QT (EQT). Specifically, a representation manner of the basic block partitioning structure of QT+BT+EQT in AVS3 in a bitstream is shown in FIG. 5. For one CU, first, whether QT is adopted for partitioning is determined, and if QT is adopted, the CU is directly partitioned according to QT. If QT is not adopted, whether partitioning is not performed is further determined, and if partitioning is not performed, the process ends. If partitioning needs to be performed, whether EQT or BT is adopted further needs to be determined. In addition, regardless of whether EQT or BT is adopted, whether horizontal portioning or vertical portioning is adopted needs to be determined. Block partitioning is a recursive partitioning decision starting from LCU from top to bottom. In the recursion process, an optimal partitioning manner and coding mode are optimized and determined by an encoding end.

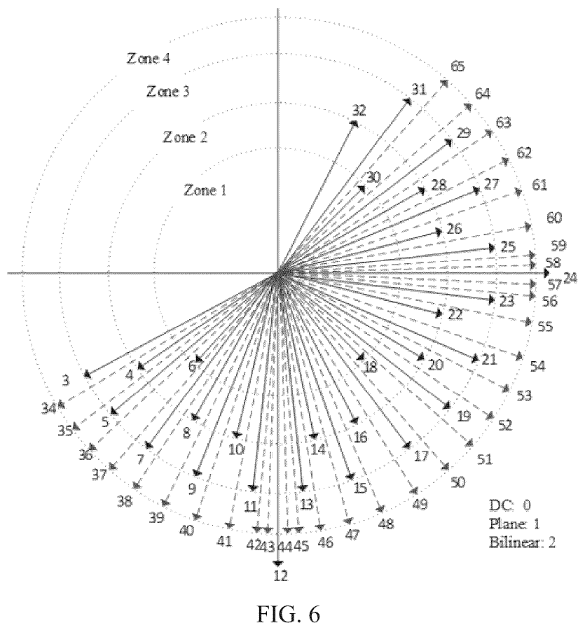

Intraframe prediction is a common predictive coding technology. Intraframe prediction derives a predicted value of a current coding block from an adjacent encoded area based on a correlation between pixels of a video picture in a space domain. The second stage of AVS3 adopts an extended intra prediction mode (EIPM). A total of 33 intraframe prediction modes are recorded in the previous-generation standard AVS2, including 30 angular prediction modes and 3 special prediction modes (a planar prediction mode, a direct current (DC) prediction mode, and a bilinear prediction mode). Two most probable modes (MPMs) are adopted for coding, and the remaining modes are adopted for 5-bit fixed-length coding. To support more precise angular prediction, 62 angular prediction modes are proposed in AVS3. As shown in FIG. 6, numbers of newly added angular prediction modes are 34 to 65.

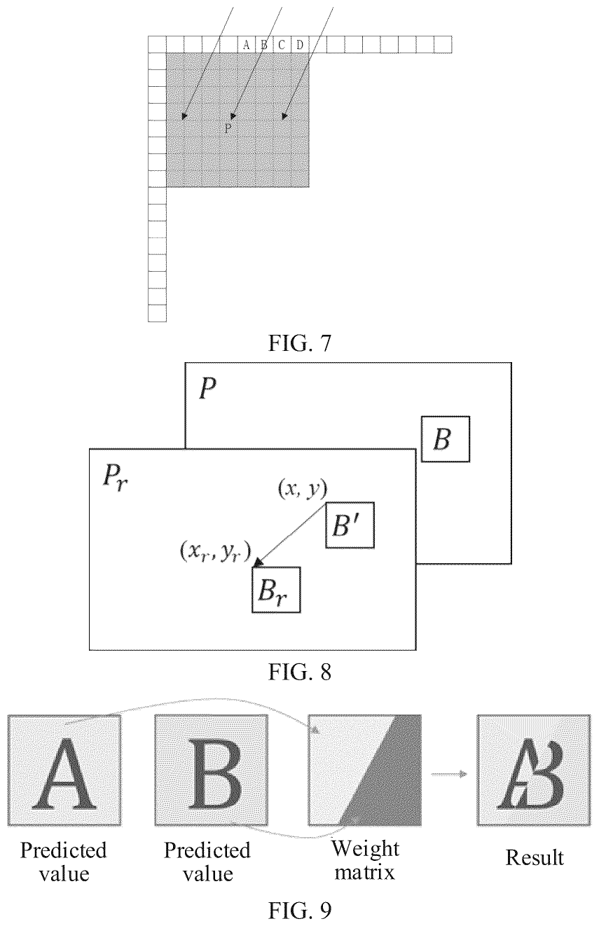

When the angular prediction mode is adopted, for pixels in a current prediction block, reference pixel values at corresponding positions on reference pixel lines or columns are taken as predicted values according to a direction corresponding to an angle of the prediction mode. As shown in FIG. 7, for a pixel P in a prediction block, a position of a reference pixel is first determined from an upper encoded pixel line according to a prediction angle in the figure, and then a value of the reference pixel is taken as a predicted value of the pixel P. In addition, not all pixel positions refer to reference pixel positions at integer-pixel precision. For example, a reference pixel position of the pixel P in FIG. 7 is a sub-pixel position between a pixel B and a pixel C. Therefore, a predicted pixel value of the position is obtained through interpolation of surrounding pixels. To improve intraframe prediction efficiency, a reference pixel for intraframe prediction is usually stored in an on-chip memory.

As shown in FIG. 8, interframe prediction uses a correlation in a time domain of a video to predict a pixel of a current picture based on a pixel of an adjacent encoded picture, whereby time domain redundancy of the video is effectively reduced and bits of encoded residual data are saved. P represents a current frame, Pr represents a reference frame, B represents a current coding block, and Br represents a reference block of B. Coordinates of B′ in the reference frame are the same as coordinates of B in the current frame, coordinates of Br are (xᵣ, yᵣ), coordinates of B′ are (x, y), a displacement between the current coding block and the reference block thereof is referred to as a motion vector (MV), and MV=(xᵣ−x, yᵣ−y).

The second stage of AVS3 further adopts an angular weighted prediction (AWP) mode for interframe prediction and a spatial angular weighted prediction (SAWP) for intraframe prediction. As shown in FIG. 9, in the AWP mode, a weight value of each pixel position is derived based on an intraframe angular prediction idea: First, reference weight values of peripheral positions (an integer-pixel position and a sub-pixel position) of a current block are set, then a weight value corresponding to each pixel position is obtained by the angular prediction method, and then weighted prediction of two different interframe prediction values is implemented based on the obtained weights. In the SAWP mode, a weight is derived by a similar method to implement weighted prediction of two intraframe prediction values. The following describes the AWP mode.

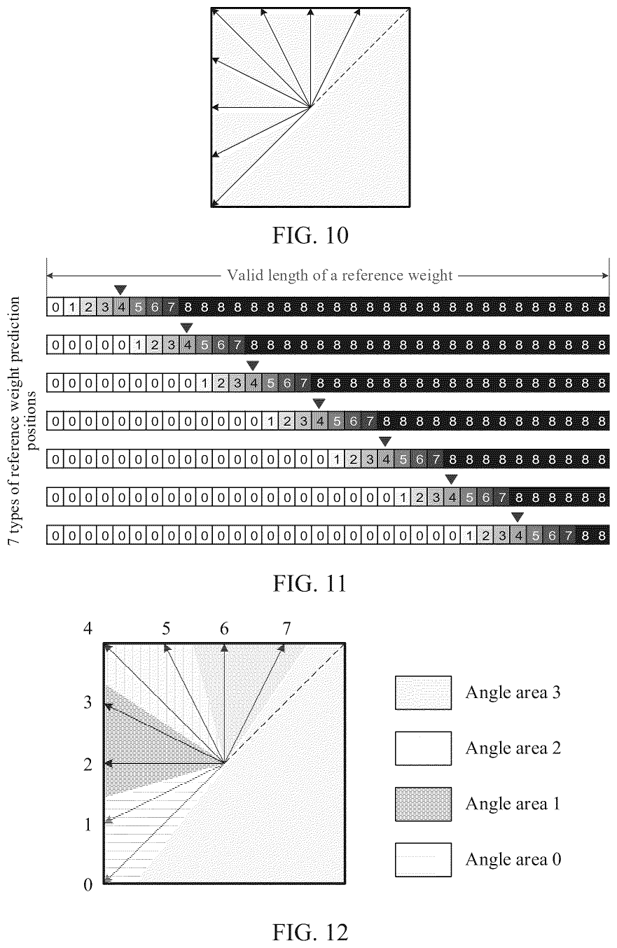

The AWP mode supports a minimum block size of 8, a maximum block size of 64, and a total of eight angles. As shown in FIG. 10, there are a total of five absolute values of slopes of the eight angles, which are respectively {horizontal, vertical, 1, 2, ½}. As shown in FIG. 11, each angle supports 7 reference weight configurations. Therefore, for each block, a total of 56 AWP modes are provided. The reference weight configuration is a distribution function of a reference weight value obtained according to a reference weight index value, which assigns a value through a non-strictly monotonically increasing function with 8 equally divided points of a valid length of a reference weight serving as reference points. The valid length of the reference weight is calculated based on a prediction angle and a size of a current block.

As shown in FIG. 12, angles supported by the AWP mode are divided into four areas, namely, an angle area 0, an angle area 1, an angle area 2, and an angle area 3. According to different areas in which angles are located, formulas for deriving a weight of each pixel are slightly different. Specifically, AwpIndex in a bitstream indicates a weight mode used by a current coding block, and relevant parameters of the AWP mode are determined according to AwpIndex by using the following formula.

$$stepIndex = ( AwpIndex >> 3 ) - 3$$

$$modAngNum = AwpIndex \%8$$

$$angleAreaIndex = modAngNum >> 1$$

$$angleIndex = \{ \begin{matrix}7 , if modAngNum == 2 \\ 8 , if modAngNum == 6 \\ modAngNum \%2\end{matrix}$$

“>>” in the foregoing formula represents a right shift operation. After the foregoing parameters are obtained, a weight matrix of the AWP mode may be derived according to the parameters by the following method.

First, a valid length vL of a reference weight is calculated. The length vL of the reference weight is represented by ½-pixel precision. For first four angles (namely, a case that an angle area index angleAreaIndex is equal to 0 or 1), the reference weight is located in a column to the left of a current block. For the last four angles (namely, a case that the angle area index angleAreaIndex is equal to 2 or 3), the reference weight is located in a row above the current block. If a width of the current block is W and a height is H, the valid length vL is calculated according to Table 1.

TABLE 1

| angleAreaIndex | vL |
|---|---|
| 0 | (H + (W >> angleIndex)) << 1 |
| 1 | |
| 2 | (W + (H >> angleIndex)) << 1 |
| 3 | |

“<<” in Table 1 represents a left shift operation. After the valid length vL of the reference weight is calculated, the reference weight Lw is populated at each sample point position x (x≤vL). PictureAwpRefineIndex is a picture header index for controlling whether to adjust the reference weight.

$$Lw [ x ] = Clip 3 ( 0 , 8 , ( x - fP ) << shift )$$

$$shift = PictureAwpRefineIndex ? 2 : 0$$

$$o = PictureAwpRefineIndex ? 3 : 1$$

A value of tP is determined according to Table 2.

TABLE 2

| angleAreaIndex | fP |
|---|---|
| 0 | (vL >> 1) − 3 − 0 + stepIndex * ((vL >> 3) − 1) |
| 1 | (vL >> 1) − 1 − 0 + stepIndex * ((vL >> 3) − 1) − |
| | ((W << 1) >> angleIndex) |
| 2 | (vL >> 1) − 1 − 0 + stepIndex * ((vL >> 3) − 1) − |
| | ((H << 1) >> angleIndex) |
| 3 | (vL >> 1) − 3 − 0 + stepIndex * ((vL >> 3) − 1) |

Next, a luminance weight matrix is filled according to the reference weight. The luminance weight matrix is set to BwLuma(x, y), and BwLuma(x, y)=Lw[tP].

For an SAWP mode or an AWP mode in a B frame, a value of tP is determined according to Table 3.

TABLE 3

| angleAreaIndex | tP |
|---|---|
| 0 | (y << 1) + ((x << 1) >> angleIndex) |
| 1 | (y << 1) − ((x << 1) >> angleIndex) |
| 2 | (x << 1) − ((y << 1) >> angleIndex) |
| 3 | (x << 1) + ((y << 1) >> angleIndex) |

For an AWP mode in a P frame, a value of tP is determined according to Table 4.

TABLE 4

| angleAreaIndex | tP |
|---|---|
| 0 | ((y >> 2) << 3) + 4 + ((((x >> 2) << 3) + 4) >> |
| | angleIndex) |
| 1 | ((y >> 2) << 3) + 4 − ((((x >> 2) << 3) + 4) >> |
| | angleIndex) |
| 2 | ((x >> 2) << 3) + 4 − ((((y >> 2) << 3) + 4) >> |
| | angleIndex) |
| 3 | ((x >> 2) << 3) + 4 + ((((y >> 2) << 3) + 4) >> |
| | angleIndex) |

After the luminance weight matrix is obtained, a chrominance weight matrix BwChroma(x, y) is filled according to the luminance weight matrix.

For the SAWP mode or the AWP mode in the B frame, a chrominance weight matrix is derived by using the following formula:

$$BwChroma [ x ] [ y ] = BwLuma [ x << 1 ] [ y << 1 ]$$

For the AWP mode in the P frame, a chrominance weight matrix is derived by using the following formula:

$$BwChroma [ x ] [ y ] = BwLuma [ ( x >> 2 ) << 3 ] [ ( y >> 2 ) << 3 ]$$

Finally, a weighted prediction value pred_{x,y} is calculated according to the derived weight matrix and the predicted value.

$${pred}_{x , y} = {predA}_{x , y} * {w}_{x , y} + {predB}_{x , y} * ( 1 - {w}_{x , y} )$$

where predA_{x,y} and predB_{x,y} represents two predicted values of weighted prediction, w_{x,y} represents a weight value at a position (x, y), when the weight is 0, the predicted value is predB_{x,y}; or when the weight is a maximum value of 1, the predicted value is predA_{x,y}.

During video coding, a weight is quantized into an integer to reduce floating point operations. A range of the weight is set to [0, m], and a value of m is set according to precision of the weight. For example, if the weight is represented by 3 bits, m=8. Therefore, a formula of the weighted prediction value pred_{x,y} may be expressed as:

$${pred}_{x , y} = ( {predA}_{x , y} * {w}_{x , y} + {predB}_{x , y} * ( 8 - {w}_{x , y} ) + 4 ) >> 3$$

where when the weight is 0, the predicted value is predB_{x,y}, or when the weight is a maximum value of m, the predicted value is predA_{x,y}.

The weight matrix w_{x,y} in AWP and SAWP is derived according to the reference weight. A range of a blending area of the reference weight is set to L, a range thereof may be determined based on a starting position and an end position (p₀, p₁), and values of p₀ and p₁ may be the same or different. A reference weight wᵢ may be derived by using the following formula:

$${w}_{i} = \{ \begin{matrix}0 , & {x}_{i} ∈ ( - ∞ , {p}_{0} ] \\ f ( d ) , & {x}_{i} ∈ ( {p}_{0} , {p}_{1} ) \\ m , & {x}_{i} ∈ [ {p}_{1} + ∞ )\end{matrix}$$

$$or$$

$${w}_{i} = \{ \begin{matrix}0 , & {x}_{i} ∈ ( - ∞ , {p}_{0} ] \\ f ( d ) , & {x}_{i} ∈ [ {p}_{0} , {p}_{1} ] \\ m , & {x}_{i} ∈ ( {p}_{1} + ∞ )\end{matrix}$$

It can be known from the foregoing formula that in the blending area, the reference weight satisfies w=ƒ(d).

During specific implementation, for a function whose value range is greater than the value range of the weight, the function may be clipped by using a clip function, that is, w=clip(0, m, ƒ(d)). Alternatively, an integer weight may be adopted to reduce complexity.

A position of a partition boundary is set to c, a distance between a sample point xᵢ on the reference weight and the blending area is set to d. d may be determined according to a distance between a current sample point and the blending area, that is, d=xᵢ−c.

Alternatively, d may be calculated according to a range of the blending area. It is assumed that offset is an offset from a center position to a starting position, d may be expressed as: d=xᵢ−p₀+offset.

d may be represented by a preset precision integer. For example, d may be represented by, but is not limited to, 8-pixel precision, 4-pixel precision, 2-pixel precision, 1-pixel precision, ½-pixel precision, ¼-pixel precision, or 1/64-pixel precision. In addition, the weight quantized into an integer may be obtained by using the following formula: w_{q}=round (m*ƒ(d)); or, may be calculated by the following formula:

$${w}_{q} = clip ( 0 , m , round ( m * f ( {d}_{q} ) ) )$$

where m is a maximum weight value, round( ) is a rounding function, and ƒ(d) is a function derived for the reference weight.

In the related art, the reference weight derivation function is a fixed linear function. However, the fixed linear function cannot adapt to all coding blocks, which affects improvement of coding performance to an extent. Based on this, the technical solutions in the embodiments of this application are provided, whereby a reference weight derivation function may be adaptively selected for a coding block and indicated by bitstream information. Therefore, a more accurate weight matrix may be derived for different coding blocks, to help improve encoding/decoding performance.

The following describes implementation details of the technical solutions in the embodiments of this application in detail.

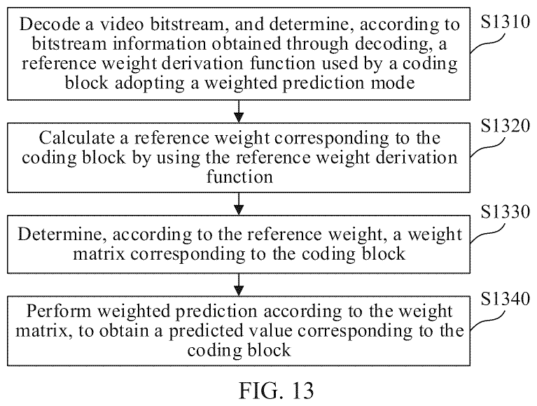

FIG. 13 is a flowchart of a video decoding method according to an embodiment of this application. The video decoding method may be performed by a device with a computing function, such as a terminal device or a server. As shown in FIG. 13, the video decoding method includes at least operation S1310 to operation S1340. A detailed description is as follows:
Operation S1310: Decode a video bitstream, and determine, according to bitstream information obtained through decoding, a reference weight derivation function used by a coding block adopting a weighted prediction mode. In an embodiment, the coding block in the weighted prediction mode may be a coding block adopting an AWP mode, namely, a coding block adopting an AWP mode or a coding block adopting an SAWP mode. In an embodiment, the reference weight derivation function used by the coding block adopting the weighted prediction mode is selected from the following functions: a linear function, a sigmoid function, a hyperbolic function, a trigonometric function, an exponential function, a polynomial function, a piecewise function, or another non-linear function.

In an embodiment of this application, the video bitstream is a bitstream obtained by encoding a video picture frame sequence. The video picture frame sequence includes a series of pictures. Each picture may be further partitioned into slices or patches. The slice may be further partitioned into a series of LCUs (or CTUs). The LCU includes a plurality of CUs. A video picture frame is encoded in units of blocks. In the embodiments of this application, the coding block may be a CU or a block smaller than the CU, such as a smaller block obtained by partitioning the CU.

In some embodiments, the reference weight derivation function may alternatively be one or more tables configured for indicating a mapping relationship between a target distance and a reference weight. The target distance is a distance between a sample point and a blending boundary. The mapping relationship table stores the mapping relationship between the target distance and the reference weight. The reference weight in the mapping relationship table is generated according to the target distance and a preset function, or is generated according to the target distance and the preset function and then adjusted. In addition, the distance between the sample point and the blending boundary may be a distance between the sample point and a starting point of the blending boundary, or may be a distance between the sample point and a center point of the blending boundary, or may be a distance between the sample point and an end point of the blending boundary, or the like. Certainly, an offset value may further be added based on these distances.

In some embodiments, the operation of determining, according to bitstream information obtained through decoding, a reference weight derivation function used by a coding block adopting a weighted prediction mode may include: the reference weight derivation function used by the coding block adopting the weighted prediction mode is determined according to explicit index information obtained through decoding; or the reference weight derivation function used by the coding block adopting the weighted prediction mode may be determined in an implicit manner according to the bitstream information obtained through decoding; or the reference weight derivation function used by the coding block adopting the weighted prediction mode may be determined in an implicit manner based on explicit index information according to bitstream information obtained through decoding.

In an embodiment of this application, the reference weight derivation function used by the coding block may be determined according to explicit index information in sequence header information. Specifically, the reference weight derivation function used by the coding block adopting the weighted prediction mode in a current sequence may be determined according to a value of sequence weight index information (such as seq_weight_index) included in the sequence header information obtained through decoding. For example, one reference weight derivation function list is set, and the reference weight derivation function used by the current sequence is indicated by the sequence weight index information. In an embodiment, the sequence header information may include a sequence weight flag bit (such as seq_weight_flag), which is configured for indicating whether the current sequence allows selection of the reference weight derivation function. For example, if a value of the sequence weight flag bit is 1, it indicates that the current sequence allows selection of the reference weight derivation function; or if the value of the sequence weight flag bit is 0, it indicates that the current sequence allows selection of the reference weight derivation function.

In addition, the sequence header information may include both the sequence weight index information (seq_weight_index) and the sequence weight flag bit (seq_weight_flag). In this case, if the sequence weight flag bit indicates that the current sequence allows selection of the reference weight derivation function, the sequence weight index information is obtained by decoding the video bitstream; or if the sequence weight flag bit indicates that the current sequence does not allow selection of the reference weight derivation function, the sequence weight index information does not need to be obtained by decoding the video bitstream. In another case, the sequence header information may include only one of the sequence weight index information (seq_weight_index) or the sequence weight flag bit (seq_weight_flag). If only the sequence weight flag bit (seq_weight_flag) is included, the reference weight derivation function may be determined according to other information (such as one or more of picture header information, patch header information, and block-level information) in the bitstream. In an embodiment, the sequence header information may further include function parameter index information, which is configured for indicating a function parameter used by the reference weight derivation function; or is configured for indicating an index position of the function parameter used by the reference weight derivation function (for example, one function parameter list is provided, and one function parameter is selected from the function parameter list based on the function parameter index information).

In an embodiment of this application, the reference weight derivation function used by the coding block may be determined based on explicit index information in the picture header information. Specifically, the reference weight derivation function used by the coding block adopting the weighted prediction mode in a current picture may be determined according to a value of picture weight index information (such as pic_weight_index) included in the picture header information obtained through decoding. For example, one reference weight derivation function list is set, and the reference weight derivation function used by the current picture is indicated by the picture weight index information. In an embodiment, the picture header information may include a picture weight flag bit (such as pic_weight_flag), which is configured for indicating whether the current picture allows selection of the reference weight derivation function. For example, if a value of the picture weight flag bit is 1, it indicates that the current picture allows selection of the reference weight derivation function; or if the value of the picture weight flag bit is 0, it indicates that the current picture does not allow selection of the reference weight derivation function.

In addition, the picture header information may include both the picture weight index information (pic_weight_index) and the picture weight flag bit (pic_weight_flag). In this case, if the picture weight flag bit indicates that the current picture allows selection of the reference weight derivation function, the picture weight index information is obtained by decoding the video bitstream; or if the picture weight flag bit indicates that the current picture does not allow selection of the reference weight derivation function, the picture weight index information does not need to be obtained by decoding the video bitstream. In another case, the picture header information may include only one of the picture weight index information (pic_weight_index) and the picture weight flag bit (pic_weight_flag). If only the picture weight flag bit (pic_weight_flag) is included, the reference weight derivation function may be determined according to other information (such as one or more of the patch header information and the block-level information) in the bitstream. In an embodiment, the picture header information may further include function parameter index information, which is configured for indicating a function parameter used by the reference weight derivation function; or is configured for indicating an index position of the function parameter used by the reference weight derivation function (for example, one function parameter list is provided, and one function parameter is selected from the function parameter list based on the function parameter index information).

In an embodiment of this application, the reference weight derivation function used by the coding block may be determined according to explicit index information in the patch header information. Specifically, the reference weight derivation function used by the coding block adopting the weighted prediction mode in a current patch may be determined according to a value of patch weight index information (such as patch_weight_index) included in the patch header information obtained through decoding. For example, one reference weight derivation function list is set, and the reference weight derivation function used by the current patch is indicated by the patch weight index information. In an embodiment, the patch header information may include a patch weight flag bit (such as patch_weight_flag), which is configured for indicating whether the current patch allows selection of the reference weight derivation function. For example, if a value of the patch weight flag bit is 1, it indicates that the current patch allows selection of the reference weight derivation function; or if the value of the patch weight flag bit is 0, it indicates that the current patch does not allow selection of the reference weight derivation function.

In addition, the patch header information may include both the patch weight index information (patch_weight_index) and the patch weight flag bit (patch_weight_flag). In this case, if the patch weight flag bit indicates that the current patch allows selection of the reference weight derivation function, the patch weight index information is obtained by decoding the video bitstream; or if the patch weight flag bit indicates that the current patch does not allow selection of the reference weight derivation function, the patch weight index information does not need to be obtained by decoding the video bitstream. In another case, the patch header information may include only one of the patch weight index information (patch_weight_index) and the patch weight flag bit (patch_weight_flag). If only the patch weight flag bit (patch_weight_flag) is included, the reference weight derivation function may be determined according to other information (such as the block-level information) in the bitstream. In an embodiment, the patch header information may further include function parameter index information, which is configured for indicating a function parameter used by the reference weight derivation function; or is configured for indicating an index position of the function parameter used by the reference weight derivation function (for example, one function parameter list is provided, and one function parameter is selected from the function parameter list based on the function parameter index information).

In addition, when the reference weight derivation function used by the coding block is indicated by one or more of the sequence header information, the picture header information, and the patch header information, the reference weight derivation function may be only valid for a coding block adopting an AWP mode, that is, the information is only configured for determining a reference weight derivation function used by the coding block adopting the AWP mode; or the reference weight derivation function may be only valid for a coding block adopting an SAWP mode, that is, the information is only configured for determining a reference weight derivation function used by the coding block adopting the SAWP mode; or the reference weight derivation function may be valid for both the coding block adopting the AWP mode and the coding block adopting the SAWP mode, that is, the information is configured for determining both the reference weight derivation function used by the coding block adopting the AWP mode and the reference weight derivation function used by the coding block adopting the SAWP mode. Alternatively, the coding block adopting the AWP mode and the coding block adopting the SAWP mode may be respectively indicated.

In an embodiment of this application, the reference weight derivation function used by the coding block may be determined according to explicit index information in the block-level information. Specifically, the reference weight derivation function used by the coding block may be determined according to a value of reference weight index information (such as ref_weight_idx) included in the block-level information obtained through decoding. For example, one reference weight derivation function list is set, and a reference weight derivation function used by a current coding block is indicated by the reference weight index information.

In addition, during decoding, a weight mode number (namely, weight_mode, which may be, for example, AwpIndex or SawpIndex) of a weighted prediction mode (such as an AWP mode) used by the coding block needs to be obtained through decoding. Therefore, if the value of the reference weight index information is first obtained by decoding from the video bitstream, a maximum available weight mode number of the weighted prediction mode adopted by the coding block may be determined according to the value of the reference weight index information. For example, a mapping relationship between the value of the reference weight index information and the maximum available weight mode number of the weighted prediction mode may be preset, and then the maximum available weight mode number of the weighted prediction mode adopted by the coding block is determined according to the value of the reference weight index information first obtained through decoding. The maximum available weight mode number may be configured for identifying a maximum quantity of available weight modes.

If a weight mode number of the weighted prediction mode adopted by the coding block is first obtained by decoding the video bitstream, a set of reference weight derivation functions may be determined according to the weight mode number. For example, a mapping relationship between the weight mode number and the set of reference weight derivation functions may be preset, and then the set of reference weight derivation functions is determined according to the weight mode number first obtained through decoding. In this way, according to the weight mode number, function sets having different quantities, or function sets having a same quantity but different types, or function sets having different quantities and different types may be determined.

In addition, the weight mode number in the foregoing embodiments may be represented by at least one of weight position index information and weight angle index information. If the weight mode number is represented by the weight position index information only, eight types may be provided; if the weight mode number is represented by the weight angle index information only, seven types may be provided; or if the weight mode number is represented by both the weight position index information and the weight angle index information, 7×8=56 types may be provided.

In an embodiment of this application, the reference weight derivation function used by the coding block may be determined based on another type of explicit index information in the block-level information. Specifically, costs respectively corresponding to a plurality of set reference weight derivation functions used by the coding block may be calculated according to the block-level information obtained through decoding, then the plurality of reference weight derivation functions are sorted according to the costs, to obtain a reference weight derivation function list, and further the reference weight derivation function used by the coding block may be selected from the reference weight derivation function list according to order index information included in the block-level information.

In an embodiment of this application, a process of determining, in an implicit manner, the reference weight derivation function used by the coding block adopting the weighted prediction mode may be determined according to the weighted prediction mode adopted by the coding block. For example, if it is determined, according to the bitstream information obtained through decoding, that the coding block adopts the AWP mode, it is determined that the coding block uses a set first reference weight derivation function; or if it is determined, according to the bitstream information obtained through decoding, that the coding block adopts the SAWP mode, it is determined that the coding block uses a set second reference weight derivation function. The first reference weight derivation function and the second reference weight derivation function may be different or the same.

In an embodiment of this application, the process of determining, in an implicit manner, the reference weight derivation function used by the coding block adopting the weighted prediction mode may include: a weight mode number of the weighted prediction mode adopted by the coding block is determined according to the block-level information obtained through decoding, a value of the reference weight index information is calculated according to the weight mode number, and a set of reference weight derivation functions used by the coding block are determined according to the value of the reference weight index information. In addition, the set of reference weight derivation functions may include one or more reference weight derivation functions. If only one reference weight derivation function is included, the reference weight derivation function is taken as the reference weight derivation function used by the coding block; or if a plurality of reference weight derivation functions are included, one of the plurality of reference weight derivation functions may be selected (for example, selected according to costs or selected in another manner) as the reference weight derivation function used by the coding block.

In an embodiment of this application, the process of determining, in an implicit manner, the reference weight derivation function used by the coding block adopting the weighted prediction mode may include: if it is determined, according to the bitstream information obtained through decoding, that the coding block is a coding block of a set size, it is determined that the coding block uses a set of set reference weight derivation function. That is, in this embodiment, for the coding block of the set size, a set of reference weight derivation functions used by the coding block may be preset. In an embodiment, the set of reference weight derivation functions may include one or more reference weight derivation functions.

In an embodiment of this application, the process of determining, in an implicit manner, the reference weight derivation function used by the coding block adopting the weighted prediction mode may include: a set of reference weight derivation functions used by the coding block are determined according to a size of the coding block included in the bitstream information obtained through decoding, coding blocks of different sizes using different reference weight derivation functions. In an embodiment, the set of reference weight derivation functions may include one or more reference weight derivation functions.

In an embodiment of this application, the process of determining, in an implicit manner, the reference weight derivation function used by the coding block adopting the weighted prediction mode may include: costs corresponding to set reference weight derivation functions used by the coding block are calculated according to the block-level information obtained through decoding, and a reference weight derivation function corresponding to a minimum cost is taken as the reference weight derivation function used by the coding block.

In an embodiment of this application, the process of determining, in an implicit manner, the reference weight derivation function used by the coding block adopting the weighted prediction mode may include: costs respectively corresponding to a plurality of set reference weight derivation functions used by the coding block are calculated according to the block-level information obtained through decoding, the plurality of reference weight derivation functions are sorted according to the costs, and a weight derivation function sorted in a set order is selected as the reference weight derivation function used by the coding block.

It can be learned that in the embodiment of this application, the reference weight derivation function used by the coding block may be indicated by the explicit index information in the sequence header information, the picture header information, the patch header information, and the block-level information. Alternatively, the reference weight derivation function used by the coding block may be determined in an implicit manner based on the block-level information. In practice, these manners may be used alone or any number thereof may be used in combination with each other. For example, the explicit index information included in at least one of the sequence header information, the picture header information, and the patch header information indicates that a reference weight may be derived by using a non-linear function, and a current coding block determines, according to a block size or in another implicit manner mentioned in the foregoing embodiments, whether the current coding block uses a linear function or a non-linear function. For another example, the explicit index information included in at least one of the sequence header information, the picture header information, or the patch header information indicates that a reference weight may be derived by using a plurality of functions, and the current coding block determines, according to a block size or in another implicit manner mentioned in the foregoing embodiments, a quantity of functions allowed to be used by the current coding block. If the quantity of available functions is greater than 1, the used reference weight derivation function is determined according to explicit block-level index information; otherwise (that is, only one available function is provided), the function is directly used.

In some embodiments, a weight mode number of the weighted prediction mode adopted by the coding block may be determined according to the block-level information obtained through decoding, a value of the reference weight index information is calculated according to the weight mode number, and a function parameter of the reference weight derivation function used by the coding block is determined according to the value of the reference weight index information; or the function parameter of the reference weight derivation function used by the coding block may be determined according to a value of the reference weight index information included in the block-level information obtained through decoding. That is, in this embodiment, the value of the reference weight index information determined according to the block-level information is configured for indicating the function parameter of the reference weight derivation function.

In some embodiments, the bitstream information involved above further includes blending area length index information, which is configured for indicating a length of a blending area to which the reference weight derivation function is applicable; or the bitstream information involved above is configured for determining, in an implicit manner, the length of the blending area to which the reference weight derivation function is applicable (for example, the length of the blending area may be implicitly determined based on the determined reference weight derivation function or parameters of the reference weight derivation function). In an embodiment, reference weight derivation functions used for blending areas of different lengths are the same or different; and function parameters of the reference weight derivation functions used for the blending areas of different lengths are the same or different.

Refer to FIG. 13 again. Operation S1320: Calculate a reference weight corresponding to the coding block by using the reference weight derivation function. In an embodiment, the operation of calculating a reference weight corresponding to the coding block by using the reference weight derivation function includes: a distance between a sample point in the coding block and a blending boundary is introduced into the reference weight derivation function to obtain a corresponding reference weight. The distance between the sample point and the blending boundary may be a distance between the sample point and a starting point of the blending boundary, or may be a distance between the sample point and a center point of the blending boundary, or may be a distance between the sample point and an end point of the blending boundary, or the like. Certainly, an offset value may further be added based on these distances.
Operation S1330: Determine, according to the reference weight, a weight matrix corresponding to the coding block.

In some embodiments, the operation of determining, according to the reference weight, the weight matrix corresponding to the coding block may include: the weight matrix corresponding to the coding block is calculated according to the reference weight and a weight prediction angle used by the coding block. For a specific calculation process, refer to descriptions in the foregoing embodiments. Details are not described herein again.

In some embodiments, the operation of determining, according to the reference weight, the weight matrix corresponding to the coding block may include: a candidate weight matrix corresponding to the coding block is calculated based on the reference weight and a prediction angle used by the coding block (a process of calculating the candidate weight matrix is similar to the process of calculating the weight matrix corresponding to the coding block based on the reference weight and the weight prediction angle used by the coding block in the foregoing embodiments), and mapping is performed on the candidate weight matrix according to a set weight mapping table, to obtain the weight matrix corresponding to the coding block. According to the technical solution in this embodiment, mapping is performed on the calculated weight matrix. During actual implementation, for example, there are two reference weight derivation functions (a description is made by taking a linear function and a sigmoid function as examples), for a same independent variable d (a distance between a sample point and a blending boundary), two weight values (w1, w2) may be derived by using the two functions, and for different d, a mapping table of the weight w1 to the weight w2 may be obtained. In this case, an encoder only needs to store one reference weight derivation function and related parameters. In this way, it is assumed that the linear function and related parameters are stored. If a reference weight needs to be derived by using the sigmoid function, the reference weight may be obtained by performing calculation by using the linear function and then by performing mapping based on the mapping table. This manner can reduce space occupied by storing a plurality of functions, can reduce a calculation amount, and help improve encoding/decoding performance.
Operation S1340: Perform weighted prediction according to the weight matrix, to obtain a predicted value corresponding to the coding block.

In some embodiments, for a process of performing weighted prediction according to the weight matrix, to obtain a predicted value corresponding to the coding block, refer to descriptions in the foregoing embodiments. Details are not described again.

In conclusion, the technical solutions in the embodiments of this application are provided, whereby the reference weight derivation function may be adaptively selected for the coding block and indicated by the bitstream information. Therefore, a more accurate weight matrix may be derived for different coding blocks, to help improve encoding/decoding performance.

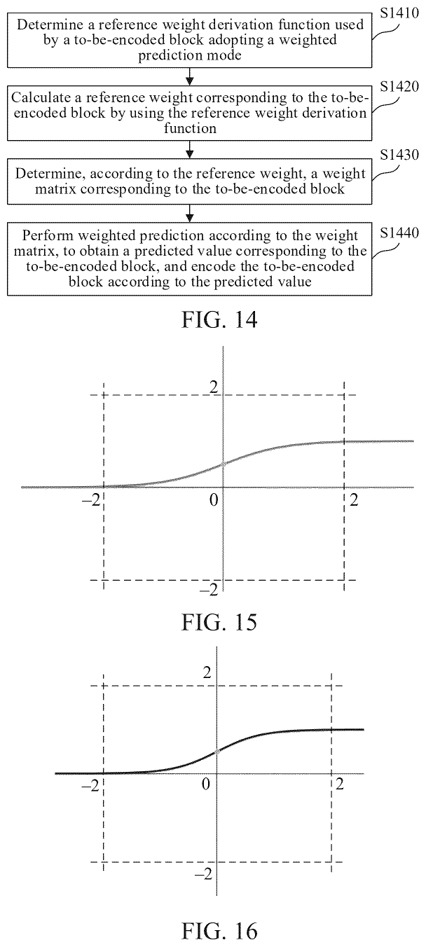

FIG. 14 is a flowchart of a video encoding method according to an embodiment of this application. The video encoding method may be performed by a device with a computing function, such as a terminal device or a server. As shown in FIG. 14, the video encoding method includes at least operation S1410 to operation S1440. A detailed description is as follows:
Operation S1410: Determine a reference weight derivation function used by a to-be-encoded block adopting a weighted prediction mode.
Operation S1420: Calculate a reference weight corresponding to the to-be-encoded block by using the reference weight derivation function.
Operation S1430: Determine, according to the reference weight, a weight matrix corresponding to the to-be-encoded block.
Operation S1440: Perform weighted prediction according to the weight matrix, to obtain a predicted value corresponding to the to-be-encoded block, and encode the to-be-encoded block according to the predicted value.

In addition, a specific processing process of an encoder is similar to that of the decoder, and details are not described herein again. If the encoder needs to indicate the reference weight derivation function by explicit index information, the encoder needs to encode a video bitstream.

The following describes implementation details of the technical solutions in the embodiments of this application in detail again from the perspective of the encoder.

In the embodiments of this application, the reference weight derivation function is extended, and a plurality of types of reference weight derivation functions may be used. Details are as follows:

In the following functions, d represents a distance between a sample point and a blending boundary, which may be a distance between the sample point and a starting point of the blending boundary, or may be a distance between the sample point and a center point of the blending boundary, or may be a distance between the sample point and an end point of the blending boundary, or the like. Certainly, an offset value may further be added based on these distances. In an embodiment, the distance represented by d may be directional. For example, a sample point position is pos, and the blending boundary is c, a value of d is equal to pos-c. If the value of d is negative, it indicates that the sample point is on the left of the blending boundary, or if the value of d is positive, it indicates that the sample point is on the right of the blending boundary. Alternatively, the distance represented by d may not be directional, and an absolute value of the distance may be calculated by using abs (pos-c).

In an embodiment of this application, the reference weight derivation function may be a linear function, such as w=s*(d+k), where s and k are parameter values of the function, which may be preset values, or may be indicated by bitstream information.

In an embodiment of this application, the reference weight derivation function may be a sigmoid function, such as

$$w = \frac{1}{1 + {e}^{- s * d}} ,$$

where s and k are parameter values of the function, which may be preset values, or may be indicated by bitstream information. For example, when s=2, a picture of the function is shown in FIG. 15, and a weight of the blending area may be set according to a function value corresponding to [−2, 2].

In an embodiment of this application, the reference weight derivation function may be a hyperbolic function, such as a tanh function w=0.5*tanh (s*d)+0.5, where s is a parameter value of the function, which may be a preset value, or may be indicated by bitstream information. For example, when s=1.3, a picture of the function is shown in FIG. 16, and a weight of the blending area may be set according to a function value corresponding to [−2, 2].

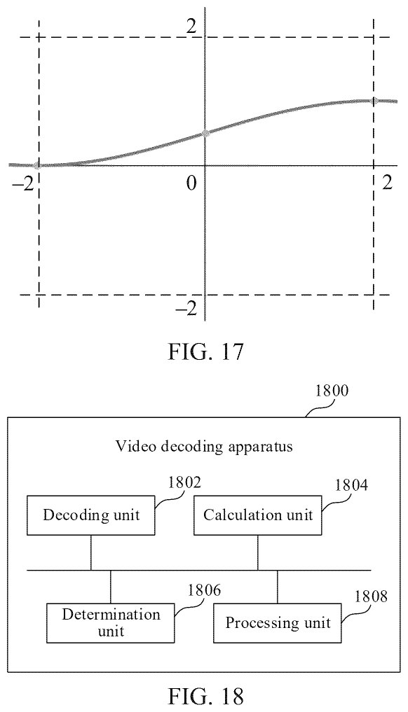

In an embodiment of this application, the reference weight derivation function may be in a trigonometric function-based form, such as a cosine function-based form:

$$w = 0.5 * cos ( \frac{( s * d - 1 ) * π}{2} ) + 0.5 ,$$

where s is a parameter value of the function, which may be a preset value, or may be indicated by bitstream information. For example, when s=0.5, a picture of the function is shown in FIG. 17, and a weight of the blending area may be set according to a function value corresponding to [−2, 2].

In an embodiment of this application, the reference weight derivation function may be an exponential function. For example, if d is less than 0, w=e^{s1(d-s2)}; or if d is greater than or equal to 0,

$$w = - \frac{1}{4 {e}^{S 1 * ( d - S 2 ) + 1}} ,$$

where s1 and s2 are parameter values of the function, which may be preset values, or may be indicated by bitstream information. For example, when s1=2, and s2=0.3465735, a weight of the blending area may be set according to a function value corresponding to [−2, 2].

In an embodiment of this application, the reference weight derivation function may be a polynomial function, such as a polynomial function having a second power.

In an embodiment of this application, the reference weight derivation function may derive a weight by using a piecewise function. According to values of d, different weight derivation functions are used. For example, when d is less than or equal to 0, the sigmoid function is used; otherwise, the linear function is used.

In an embodiment of this application, the reference weight may alternatively be generated by a table look-up method when being derived. For example, one or more look-up tables may be generated according to preset precision, and the look-up table stores a mapping relationship between d and a function value. In the weight derivation process, the reference weight is determined by looking up the function values corresponding to d, without the need of deriving the reference weight by using the foregoing function. In an embodiment, when the look-up table is constructed, further adjustment, such as +1, −1, +2, or −2, may be performed based on rounded weights.

In addition, in the embodiments of this application, d may use different precision. For example, d may use 8-pixel precision, 4-pixel precision, 2-pixel precision, 1-pixel precision, ½-pixel precision, ¼-pixel precision, 1/64-pixel precision, or the like.

Based on the foregoing reference weight derivation function, a main processing process of the embodiments of this application includes:
Process 1: Decode a bitstream, and determine a reference weight derivation function according to information in the bitstream (the following manners and methods in the manners may be used alone or in combination)

### Manner I: Decode Sequence Header Information.

In an embodiment of this application, an index seq_weight_index for indicating a use reference weight derivation function is included in a sequence header. One preset list includes a series of available reference weight derivation functions. A method whose index is seq_weight_index in the preset list is determined as a reference weight derivation function used by a current sequence. In an embodiment, a flag seq_weight_flag for indicating whether an improved reference weight derivation method (namely, the method provided in the embodiments of this application) is used is included in the sequence header. If the improved reference weight derivation method is used, seq_weight_index is decoded. In an embodiment, information for indicating a function parameter of the reference weight derivation function is included in the sequence header. Specifically, information about the function parameter may be directly obtained through decoding; or one list includes the function parameter in a specified order, and the information about the function parameter may be determined from the list according to an index seq_param_index obtained through decoding.

### Manner II: Decode Picture Header Information.

In an embodiment of this application, an index pic_weight_index for indicating a used reference weight derivation function is included in a picture header. One preset list includes a series of available reference weight derivation functions. A method whose index is pic_weight_index in the preset list is determined as a reference weight derivation function used by a current picture. In an embodiment, a flag pic_weight_flag for indicating whether a coding block in the current picture is allowed to select the reference weight derivation function is included in the picture header. If the coding block is allowed to select the reference weight derivation function, pic_weight_index is decoded. In an embodiment, an index for indicating a function parameter of the reference weight derivation function is included in the picture header. Specifically, information about the function parameter may be directly obtained through decoding; or one list includes the function parameter in a specified order, and the information about the function parameter may be determined from the list according to an index pic_param_index obtained through decoding.

### Manner III: Decode Patch Header Information.

In an embodiment of this application, an index patch_weight_index for indicating a used reference weight derivation function is included in a patch header (patch or slice). One preset list includes a series of available reference weight derivation functions. A method whose index is patch_weight_index in the preset list is determined as a reference weight derivation function used by a current patch. In an embodiment, a flag patch_weight_flag for indicating whether a coding block in the current patch is allowed to select the reference weight derivation function is included in the patch header. If the coding block is allowed to select the reference weight derivation function, patch_weight_index is decoded. In an embodiment, an index for indicating a function parameter of the reference weight derivation function is included in the patch header. Specifically, information about the function parameter may be directly obtained through decoding; or one list includes the function parameter in a specified order, and the information about the function parameter may be determined from the list according to an index patch_param_index obtained through decoding.

In addition, the foregoing sequence header, picture header, and patch header information may be used to determine a reference weight derivation function for an AWP mode only; or used to determine a reference weight derivation function for an SAWP mode only; or used to determine a reference weight derivation function for both the AWP mode and the SAWP mode, for example, seq_weight_index is used to determine the reference weight derivation function for the AWP mode and the SAWP mode; or used to respectively determine the reference weight derivation functions for the AWP mode and the SAWP mode, for example, seq_awp_weight_index is used to determine the reference weight derivation function for the AWP mode, and seq_sawp_weight_index is used to determine the reference weight derivation function for the SAWP mode.

### Manner IV: Decode Block-Level Information.

In an embodiment of this application, a bitstream is decoded, to determine a current AWP mode weight_mode, and then a current reference weight derivation function is calculated based on the mode. Because seven weight configuration manners and eight prediction angles are provided in the existing standard, that is, a total of 56 AWP modes are provided, and in the embodiments of this application, one reference weight derivation manner is added, a total of 2×7×8=112 modes are provided. After weight_mode is obtained through decoding, other parameters may be calculated in the following manner:

$$ref\_weight \_idx = weight\_mode / 56$$

$$ref\_weight \_pos \_idx = ( weight\_mode \%56 ) / 8$$

$$weight\_angle \_idx = ( weight\_mode \%56 ) \%8$$

where ref_weight_idx indicates a used reference weight derivation function; ref_weight_pos_idx represents reference weight position index information; and weight_angle_idx represents weight angle index information, and corresponds to modAngNum introduced in the foregoing embodiments.

In an embodiment of this application, the reference weight derivation function may be determined by decoding additional index information. For example, while weight_mode is obtained by decoding the bitstream, an index ref_weight_idx is additionally decoded to indicate the reference weight derivation function. The other parameters are calculated in the following manner:

$$ref\_weight \_pos \_idx = weight\_mode / 8$$

$$weight\_angle \_idx = weight\_mode \%8$$

where ref_weight_pos_idx represents the reference weight position index information; and weight_angle_idx represents weight angle index information, and corresponds to modAngNum introduced in the foregoing embodiment.

In an embodiment, when the bitstream is decoded, if ref_weight_idx is first decoded, and then a weight mode number weight_mode is decoded, a maximum available weight mode number may be determined according to ref_weight_idx. If the weight mode number weight_mode is first decoded, and then ref_weight_idx is decoded, a maximum quantity of available reference weight functions may be determined according to the weight mode number weight_mode.

weight_mode may be represented by at least one of the weight position index information and the weight angle index information. If weight_mode is represented by the weight position index information only, eight types may be provided; if weight_mode is represented by the weight angle index information only, seven types may be provided; or if weight_mode is represented by both the weight position index information and the weight angle index information, 7×8-56 types may be provided.

In an embodiment, when the used reference weight derivation function is indicated by ref_weight_idx, different reference weight derivation functions may be indicated by different values of the index. For example, a linear function and a sigmoid function are allowed to be used, and if ref_weight_idx is 0, the linear function is used; or if ref_weight_idx is 1, the sigmoid function is used. For another example, a linear function, a sigmoid function 1, and a sigmoid function 2 are allowed to be used, and if ref_weight_idx is 0, the linear function is used; if ref_weight_idx is 1, the sigmoid function 1 is used; or if ref_weight_idx is 2, the sigmoid function 2 is used. In addition, ref_weight_idx may not be configured for indicating the reference weight derivation function but is configured for indicating a function parameter of the reference weight derivation function. For example, for the sigmoid function including the parameter s in the foregoing embodiments, the bitstream may include a value of the parameter s or an index corresponding to the parameter s. It is assumed that one parameter list {½, 1, 2, 4, 8} is provided, when the index is 0, s=½, or when the index is 2, the parameter s=2.

In an embodiment of this application, an index for indicating a length of a blending area may be included in the bitstream, or the length of the blending area may be determined in an implicit manner (for example, determined according to the used reference weight derivation function or according to the parameters of the reference weight derivation function). The reference weight may be derived only in the blending area by using the indicated reference weight derivation function. The length of the blending area may be an integer, for example, may be {1, 2, 4, 8, 16} ½-pixel length. In an embodiment, the parameter of the weight derivation function may be correspondingly adjusted according to different lengths of the used blending area; or different weight derivation functions may be used according to different lengths of the blending area.

In an embodiment of this application, the used reference weight derivation function may be determined by an implicit method, without the need of decoding additional information. For example, the reference weight derivation function is determined according to a prediction mode. For example, different reference weight derivation functions may be used for an AWP mode and a SAWP mode. Alternatively, the reference weight derivation method provided in the embodiments of this application may be applied to the SAWP mode only. Alternatively, the reference weight derivation function may be determined according to a block size. For example, the method provided in the embodiments of this application is applied to a coding block of a particular size only. For example, the reference weight derivation method provided in the embodiments of this application is applied to a coding block of a block size greater than 8×8. Alternatively, different reference weight derivation functions are used by coding blocks of different sizes. Alternatively, the reference weight derivation manner may be selected by a template matching technique. For example, costs corresponding to different reference weight derivation functions are calculated, and a reference weight derivation function having a minimum cost is selected. In this case, reference weight derivation functions may alternatively be sorted according to the costs, and then a reference weight derivation function sorted in a set order is selected; or a reference weight derivation function may be selected from the sorted list based on one piece of explicit index information.
Process 2: Derive a reference weight according to the selected reference weight derivation function.

Specifically, for example, a position of first_pos (a starting point of the blending area) or center_pos (a center point of the blending area) is determined according to ref_weight_pos_idx; and d is calculated according to first_pos (or center_pos), and the reference weight is obtained based on the reference weight derivation function.
Process 3: Derive a weight matrix according to the reference weight.

In this process, a weight angle (namely, weight_angle, which corresponds to modAngNum in the foregoing embodiments) is determined according to weight_angle_idx, and then the weight matrix is obtained according to the weight angle and the reference weight. For a specific process, refer to descriptions in the foregoing embodiments. In an embodiment, a weight mapping table may alternatively be determined according to ref_weight_idx, and the derived weight matrix is mapped according to the mapping table to obtain a final weight matrix. For example, the weight matrixes are calculated by using two reference weight derivation functions, one is a final weight matrix w1=clip(0, 8, 8-d) that is derived based on a linear function, and the other one is a final weight matrix

$$w 2 = clip ( 0 , 8 , \frac{1}{1 + {e}^{- s * d}} )$$

that is derived based on a sigmoid function. For different d, a set of corresponding weights (w1, w2) may be respectively obtained, and then a look-up table from the weight w1 to the weight w2 may be obtained. For a weight matrix M1 derived according to w1, M1 may be mapped to M2 according to the look-up table.
Process 4: Perform weighted prediction based on the weight matrix to obtain a predicted value.

For this process, refer to descriptions in the foregoing embodiments. Details are not described herein again.

The following describes embodiments of specific application scenarios of this application:

In an application scenario, the technical solutions provided in the embodiments of this application may be applied to a SAWP prediction mode. d is represented by a ½-pixel. In the application scenario, a mapping function between a linear function and a sigmoid function may be calculated. It is assumed that a reference weight derived by using the linear function is expressed as f1(d), with a maximum value of 8; and a reference weight derived by using the sigmoid function is expressed as f2(d), with a maximum value of 16. Then, in a case of d={−4, −3, −2, −1, 0, 1, 2, 3, 4}, the reference weight derived by using the linear function is f1(d)={0, 1, 2, 3, 4, 5, 6, 7, 8}. It is assumed that the sigmoid function is

$$w = \frac{1}{1 + {e}^{- s * d}} ,$$

and a value of a function parameter s is equal to 0.9, in a case of d={−4, −3, −2, −1, 0, 1, 2, 3, 4}, the reference weight derived by using the sigmoid function is f2(d)={0, 1, 2, 5, 8, 11, 14, 15, 16}.

After f1(d) and f2(d) are obtained, a mapping function from f1(d) to f2(d) may be constructed. In an encoding/decoding process, a reference weight clip(0, 8, d+4) may be first calculated according to the linear function, and a weight matrix BW1 is derived according to the reference weight. Then, BW1 is mapped to BW2 by using the constructed mapping function, and weighted prediction may be performed by using the following formula:

$$( P 0 * {w}_{0} + P 1 * ( 16 - {w}_{0} ) + 8 ) >> 4$$

where P0 and P1 represent two predicted values obtained through weighted prediction; and w₀ is a weight obtained through mapping in BW2.

In another application scenario, the technical solutions provided in the embodiments of this application may be applied to a SAWP mode. d is represented by a ½-pixel. In the application scenario, a reference weight may be derived by using a sigmoid function. It is assumed that the sigmoid function is

$$w = \frac{1}{1 + {e}^{- s * d}} ,$$

a value of a function parameter s is equal to 0.9, and a maximum value of the reference weight is 16, in an encoding/decoding process, after the reference weight is calculated by using the sigmoid function and a weight matrix BW is derived, weighted prediction may be performed by using the following formula:

$$( P 0 * {w}_{0} + P 1 * ( 16 - {w}_{0} ) + 8 ) >> 4$$

where P0 and P1 represents two predicted values obtained through weighted prediction; and w₀ is a weight in BW.

The following describes apparatus embodiments of this application, and the apparatus may be configured to perform the method in the foregoing embodiments of this application. For details not disclosed in the apparatus embodiments of this application, refer to the foregoing method embodiments of this application.

FIG. 18 is a block diagram of a video decoding apparatus according to an embodiment of this application. The video decoding apparatus may be disposed in a device with a computing function, such as a terminal device or a server.

As shown in FIG. 18, a video decoding apparatus 1800 according to an embodiment of this application includes: a decoding unit 1802, a calculation unit 1804, a determination unit 1806, and a processing unit 1808. The decoding unit 1802 is configured to decode a video bitstream, and determine, according to bitstream information obtained through decoding, a reference weight derivation function used by a coding block adopting a weighted prediction mode. The calculation unit 1804 is configured to calculate a reference weight corresponding to the coding block by using the reference weight derivation function. The determination unit 1806 is configured to determine, according to the reference weight, a weight matrix corresponding to the coding block. The processing unit 1808 is configured to perform weighted prediction according to the weight matrix, to obtain a predicted value corresponding to the coding block.

In some embodiments of this application, based on the foregoing solutions, the decoding unit 1802 is configured to determine the reference weight derivation function used by the coding block adopting the weighted prediction mode in at least one of the following manners: determining, according to explicit index information obtained through decoding, the reference weight derivation function used by the coding block adopting the weighted prediction mode; and determining, in an implicit manner according to the bitstream information obtained through decoding, the reference weight derivation function used by the coding block adopting the weighted prediction mode.

In some embodiments of this application, based on the foregoing solution, when determining, according to explicit index information obtained through decoding, the reference weight derivation function used by the coding block adopting the weighted prediction mode, the decoding unit 1802 is configured to: determine, according to a value of sequence weight index information included in sequence header information obtained through decoding, the reference weight derivation function used by the coding block adopting the weighted prediction mode in a current sequence.

In some embodiments of this application, based on the foregoing solutions, the sequence header information further includes a sequence weight flag bit, which is configured for indicating whether the current sequence allows selection of the reference weight derivation function. If the sequence weight flag bit indicates that the current sequence allows selection of the reference weight derivation function, the sequence weight index information is obtained by decoding the video bitstream.

In some embodiments of this application, based on the foregoing solutions, the sequence header information further includes function parameter index information, which is configured for indicating a function parameter used by the reference weight derivation function; or is configured for indicating an index position of the function parameter used by the reference weight derivation function.

In some embodiments of this application, based on the foregoing solutions, when determining, according to explicit index information obtained through decoding, the reference weight derivation function used by the coding block adopting the weighted prediction mode, the decoding unit 1802 is configured to: determine, according to a value of picture weight index information included in picture header information obtained through decoding, the reference weight derivation function used by the coding block adopting the weighted prediction mode in a current picture.

In some embodiments of this application, based on the foregoing solutions, the picture header information further includes a picture weight flag bit, which is configured for indicating whether the current picture allows selection of the reference weight derivation function. If the picture weight flag bit indicates that the current picture allows selection of the reference weight derivation function, the picture weight index information is obtained by decoding the video bitstream.

In some embodiments of this application, based on the foregoing solutions, the picture header information further includes function parameter index information, which is configured for indicating a function parameter used by the reference weight derivation function; or is configured for indicating an index position of the function parameter used by the reference weight derivation function.

In some embodiments of this application, based on the foregoing solutions, when determining, according to explicit index information obtained through decoding, the reference weight derivation function used by the coding block adopting the weighted prediction mode, the decoding unit 1802 is configured to: determine, according to a value of patch weight index information included in patch header information obtained through decoding, the reference weight derivation function used by the coding block adopting the weighted prediction mode in a current patch.

In some embodiments of this application, based on the foregoing solutions, the patch header information further includes a patch weight flag bit, which is configured for indicating whether the current patch allows selection of the reference weight derivation function. If the patch weight flag bit indicates that the current patch allows selection of the reference weight derivation function, the patch weight index information is obtained by decoding the video bitstream.

In some embodiments of this application, based on the foregoing solutions, the patch header information further includes function parameter index information, which is configured for indicating a function parameter used by the reference weight derivation function; or is configured for indicating an index position of the function parameter used by the reference weight derivation function.

In some embodiments of this application, based on the foregoing solutions, when determining, according to explicit index information obtained through decoding, the reference weight derivation function used by the coding block adopting the weighted prediction mode, the decoding unit 1802 is configured to: determine, according to the explicit index information obtained through decoding, a reference weight derivation function used by a coding block adopting an AWP mode; or determine, according to the explicit index information obtained through decoding, a reference weight derivation function used by a coding block adopting an SAWP mode; or determine, according to the explicit index information obtained through decoding, a reference weight derivation function used by coding blocks adopting the AWP mode and the SAWP mode; or respectively determine, according to the explicit index information obtained through decoding, a reference weight derivation function used by a coding block adopting the AWP mode and a reference weight derivation function used by a coding block adopting the SAWP mode.

In some embodiments of this application, based on the foregoing solutions, when determining, according to explicit index information obtained through decoding, the reference weight derivation function used by the coding block adopting the weighted prediction mode, the decoding unit 1802 is configured to: determine, according to a value of reference weight index information included in block-level information obtained through decoding, the reference weight derivation function used by the coding block.

In some embodiments of this application, based on the foregoing solutions, the processing unit is further configured to: determine, according to a value of the reference weight index information, a maximum available weight mode number of the weighted prediction mode adopted by the coding block if the value of the reference weight index information is first obtained by decoding the video bitstream; or determine a maximum quantity of available reference weight derivation functions according to a weight mode number if the weight mode number of the weighted prediction mode adopted by the coding block is first obtained by decoding the video bitstream, the weight mode number being represented by at least one of weight position index information and weight angle index information.

In some embodiments of this application, based on the foregoing solutions, when determining, according to explicit index information obtained through decoding, the reference weight derivation function used by the coding block adopting the weighted prediction mode, the decoding unit 1802 is configured to: calculate, according to the block-level information obtained through decoding, costs respectively corresponding to a plurality of set reference weight derivation functions used by the coding block, and sort the plurality of reference weight derivation functions according to the costs, to obtain a reference weight derivation function list; and select, according to order index information included in the block-level information, the reference weight derivation function used by the coding block from the reference weight derivation function list.

In some embodiments of this application, based on the foregoing solutions, the processing unit is further configured to: determine, according to the block-level information obtained through decoding, a weight mode number of the weighted prediction mode adopted by the coding block, calculate a value of the reference weight index information according to the weight mode number, and determine, according to the value of the reference weight index information, a function parameter of the reference weight derivation function used by the coding block; or determine, according to a value of the reference weight index information included in the block-level information obtained through decoding, the function parameter of the reference weight derivation function used by the coding block.

In some embodiments of this application, based on the foregoing solutions, the bitstream information obtained through decoding further includes blending area length index information, which is configured for indicating a length of a blending area to which the reference weight derivation function is applicable; or the length of the blending area to which the reference weight derivation function is applicable is determined in an implicit manner according to the bitstream information obtained through decoding. Reference weight derivation functions used for blending areas of different lengths are the same or different; and function parameters of the reference weight derivation functions used for the blending areas of different lengths are the same or different.

In some embodiments of this application, based on the foregoing solutions, when determining, in an implicit manner according to the bitstream information obtained through decoding, the reference weight derivation function used by the coding block adopting the weighted prediction mode, the decoding unit 1802 is configured to: determine that the coding block uses a set first reference weight derivation function if it is determined, according to the bitstream information obtained through decoding, that the coding block adopts an AWP mode; or determine that the coding block uses a set second reference weight derivation function if it is determined, according to the bitstream information obtained through decoding, that the coding block adopts an SAWP mode.

In some embodiments of this application, based on the foregoing solutions, when determining, in an implicit manner according to the bitstream information obtained through decoding, the reference weight derivation function used by the coding block adopting the weighted prediction mode, the decoding unit 1802 is configured to: determine, according to the block-level information obtained through decoding, a weight mode number of the weighted prediction mode adopted by the coding block, calculate a value of the reference weight index information according to the weight mode number, and determine, according to the value of the reference weight index information, a set of reference weight derivation functions used by the coding block; or determine that the coding block uses a set of set reference weight derivation functions if it is determined, according to the bitstream information obtained through decoding, that the coding block is a coding block of a specified size; or determine, according to a size of the coding block included in the bitstream information obtained through decoding, a set of reference weight derivation functions used by the coding block, coding blocks of different sizes using different reference weight derivation functions; or calculate, according to the block-level information obtained through decoding, costs corresponding to set reference weight derivation functions used by the coding block, and take a reference weight derivation function corresponding to a minimum cost as the reference weight derivation function used by the coding block; or calculate, according to the block-level information obtained through decoding, costs respectively corresponding to a plurality of reference weight derivation functions used by the coding block, sort the plurality of reference weight derivation functions according to the costs, and select a weight derivation function sorted in a set order as the reference weight derivation functions used by the coding block.

In some embodiments of this application, based on the foregoing solutions, the determination unit 1806 is configured to: calculate a weight matrix corresponding to the coding block according to the reference weight and a weight prediction angle used by the coding block; or calculate a candidate weight matrix corresponding to the coding block according to the reference weight and the prediction angle used by the coding block, and perform mapping on the candidate weight matrix according to a set weight mapping table, to obtain the weight matrix corresponding to the coding block.

In some embodiments of this application, based on the foregoing solutions, the reference weight derivation function is selected from the following functions: a linear function, a sigmoid function, a hyperbolic function, a trigonometric function, an exponential function, a polynomial function, and a piecewise function.

In some embodiments of this application, based on the foregoing solutions, the reference weight derivation function is configured for indicating a mapping relationship table between a target distance and a reference weight, and the target distance is a distance between a sample point and a blending boundary. The mapping relationship table stores a mapping relationship between the target distance and the reference weight. The reference weight in the mapping relationship table is generated according to the target distance and a preset function, or is generated according to the target distance and the preset function and then adjusted.

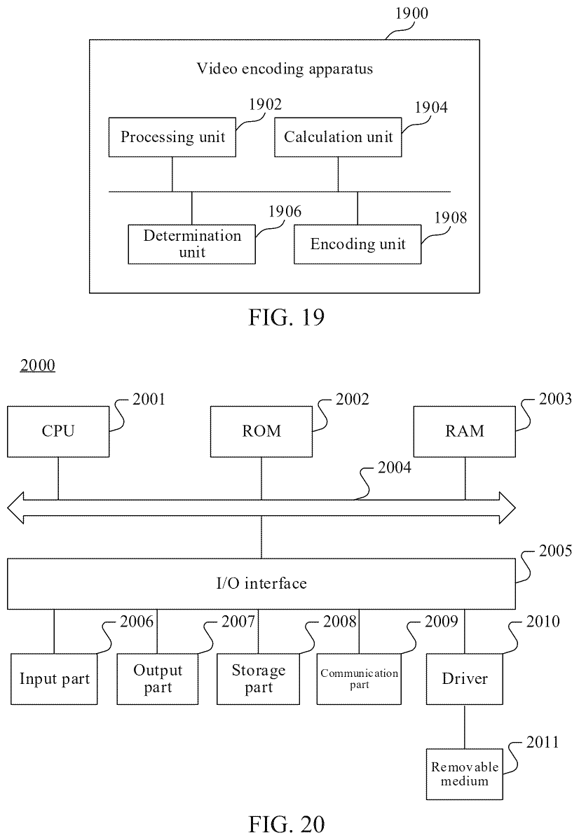

FIG. 19 is a block diagram of a video encoding apparatus according to an embodiment of this application. The video encoding apparatus may be disposed in a device with a computing function, such as a terminal device or a server.

As shown in FIG. 19, a video encoding apparatus 1900 according to an embodiment of this application includes: a processing unit 1902, a calculation unit 1904, a determination unit 1906, and an encoding unit 1908.

The processing unit 1902 is configured to determine a reference weight derivation function used by a to-be-encoded block adopting a weighted prediction mode. The calculation unit 1904 is configured to calculate a reference weight corresponding to the to-be-encoded block by using the reference weight derivation function. The determination unit 1906 is configured to determine, according to the reference weight, a weight matrix corresponding to the to-be-encoded block. The encoding unit 1908 is configured to perform weighted prediction according to the weight matrix, to obtain a predicted value corresponding to the to-be-encoded block, and encode the to-be-encoded block according to the predicted value.

FIG. 20 is a schematic structural diagram of a computer system adapted to implement an electronic device according to an embodiment of this application. The electronic device may be the video decoding apparatus or the video encoding apparatus in the foregoing embodiments.

In addition, a computer system 2000 of the electronic device shown in FIG. 20 is merely an example, and does not constitute any limitation on functions and use ranges of the embodiments of this application.

As shown in FIG. 20, the computer system 2000 may include a central processing unit (CPU) 2001, which may perform various suitable actions and processing according to a program stored in a read-only memory (ROM) 2002 or a program loaded from a storage part 2008 into a random-access memory (RAM) 2003, for example, perform the method described in the foregoing embodiments. The RAM 2003 further stores various programs and data required for system operations. The CPU 2001, the ROM 2002, and the RAM 2003 are connected to each other via a bus 2004. An input/output (I/O) interface 2005 is also connected to the bus 2004.

The following components may be connected to the I/O interface 2005: an input part 2006 including a keyboard, a mouse, and the like; an output part 2007 including a cathode ray tube (CRT), a liquid crystal display (LCD), a speaker, and the like; the storage part 2008 including a hard disk, and the like; and a communication part 2009 including a network interface card such as a local area network (LAN) card and a modem. The communication part 2009 performs communication over a network such as the Internet. A driver 2010 is also connected to the I/O interface 2005 as required. A removable medium 2011, such as a magnetic disk, an optical disc, a magneto-optical disk, or a semiconductor memory, is installed on the drive 2010 as required, whereby a computer program read from the removable medium is installed into the storage part 2008 as required.

Particularly, according to the embodiments of this application, the process described above with reference to the flowchart may be implemented as a computer software program. For example, the embodiments of this application provide a computer program product, which includes a computer program carried on a computer-readable medium. The computer program is configured for performing the method shown in the flowchart. In such an embodiment, the computer program may be downloaded and installed from a network through the communication part 2009, and/or installed from the removable medium 2011. The CPU 2001 executes the computer program, to implement various functions defined in the system of this application.

In another aspect, this application further provides a computer-readable medium. The computer-readable medium may be included in the electronic device described in the foregoing embodiments, or may exist alone without being assembled into the electronic device. The computer-readable medium carries one or more computer programs. One electronic device executes the one or more computer programs, to cause the electronic device to implement the method described in the foregoing embodiments. For example, the electronic device is a video decoding apparatus, and the video decoding apparatus may perform the video decoding method shown in FIG. 13. For another example, the electronic device is a video encoding apparatus, and the video encoding apparatus may perform the video encoding method shown in FIG. 14.

According to the descriptions of the foregoing embodiments, those skilled in the art may readily understand that the exemplary embodiments described herein may be implemented by using software, or may be implemented by using software in combination with necessary hardware. Therefore, the technical solutions in the embodiments of this application may be embodied in the form of software product. The software product may be stored in a non-volatile storage medium (which may be a compact disc read-only memory (CD-ROM), a Universal Serial Bus (USB) flash drive, a removable hard disk, or the like) or on a network, including several instructions to cause an electronic device to perform the method according to the embodiments of this application. After considering the description and practicing the embodiments disclosed herein, those skilled in the art may easily conceive of other embodiments of this application. This application is intended to cover any variations, uses, or adaptive changes of this application. These variations, uses, or adaptive changes follow the general principles of this application and include common general knowledge or common technical means in the art, which are not disclosed in this application.

This application is not limited to the precise structures described above and shown in the accompanying drawings, and various modifications and changes may be made without departing from the scope of this application. The scope of this application is subject only to the appended claims.

What is claimed is:

1. A video decoding method, comprising:
decoding a video bitstream to obtain bitstream information;
determining a reference weight derivation function used by a coded block according to the bitstream information;
calculating a reference weight corresponding to the coded block according to the reference weight derivation function;
determining, according to the reference weight, a weight matrix corresponding to the coded block; and
performing weighted prediction according to the weight matrix, to obtain a predicted value corresponding to the coded block.

2. The video decoding method according to claim 1, wherein the determining a reference weight derivation function used by a coded block according to the bitstream information comprises at least one of the following manners:
determining, according to explicit index information in the bitstream information, the reference weight derivation function used by the coded block; and
determining, in an implicit manner according to the bitstream information, the reference weight derivation function used by the coded block.

3. The video decoding method according to claim 2, wherein the determining, according to explicit index information in the bitstream information, the reference weight derivation function used by the coded block comprises at least one of the following manners:
determining, according to a value of sequence weight index information comprised in sequence header information in the bitstream information, the reference weight derivation function used by the coded block in a current sequence;
determining, according to a value of picture weight index information comprised in picture header information in the bitstream information, the reference weight derivation function used by the coded block in a current picture; and
determining, according to a value of patch weight index information comprised in patch header information in the bitstream information, the reference weight derivation function used by the coded block in a current patch.

4. The video decoding method according to claim 3, wherein the sequence header information further comprises at least one of a sequence weight flag bit and function parameter index information; and the sequence weight flag bit is configured for indicating whether the current sequence allows selection of the reference weight derivation function; and
the function parameter index information is configured for indicating a function parameter used by the reference weight derivation function; or is configured for indicating an index position of the function parameter used by the reference weight derivation function.

5. The video decoding method according to claim 3, wherein the picture header information further comprises at least one of a picture weight flag bit and function parameter index information; and the picture weight flag bit is configured for indicating whether the current picture allows section of the reference weight derivation function; and
the function parameter index information is configured for indicating a function parameter used by the reference weight derivation function; or is configured for indicating an index position of the function parameter used by the reference weight derivation function.

6. The video decoding method according to claim 3, wherein the patch header information further comprises at least one of a patch weight flag bit and function parameter index information; and the patch weight flag bit is configured for indicating whether the current patch allows selection of the reference weight derivation function; and
the function parameter index information is configured for indicating a function parameter used by the reference weight derivation function; or is configured for indicating an index position of the function parameter used by the reference weight derivation function.

7. The video decoding method according to claim 2, wherein the determining, according to the explicit index information in the bitstream information, the reference weight derivation function used by the coded block comprises:
determining, according to the explicit index information, a reference weight derivation function used by a coded block adopting an angular weighted prediction (AWP) mode; or
determining, according to the explicit index information, a reference weight derivation function used by a coded block adopting a spatial angular weighted prediction (SAWP) mode; or
determining, according to the explicit index information, a reference weight derivation function used by a coded block adopting the AWP mode and a reference weight derivation function used by a coded block adopting the SAWP mode; or
respectively determining, according to the explicit index information, a reference weight derivation function used by a coded block adopting the AWP mode and a reference weight derivation function used by a coded block adopting the SAWP mode.

8. The video decoding method according to claim 2, wherein the determining, according to the explicit index information in the bitstream information, the reference weight derivation function used by the coded block comprises:
determining, according to a value of reference weight index information comprised in block-level information in the bitstream information, the reference weight derivation function used by the coded block.

9. The video decoding method according to claim 1, further comprising:
determining, according to block-level information in the bitstream information, a weight mode number adopted by the coded block, calculating a value of the reference weight index information according to the weight mode number, and determining, according to the value of the reference weight index information, a function parameter of the reference weight derivation function used by the coded block; or
determining, according to the value of the reference weight index information comprised in the block-level information, the function parameter of the reference weight derivation function used by the coded block.

10. The video decoding method according to claim 1, wherein the bitstream information further comprises blending area length index information indicating a length of a blending area to which the reference weight derivation function is applicable; and the bitstream information is configured for determining, in an implicit manner, the length of the blending area to which the reference weight derivation function is applicable.

11. The video decoding method according to claim 1, wherein the determining, according to the reference weight, a weight matrix corresponding to the coded block comprises:
calculating the weight matrix corresponding to the coded block according to the reference weight and a weight prediction angle used by the coded block; or
calculating a candidate weight matrix corresponding to the coded block according to the reference weight and the prediction angle used by the coded block, and performing mapping on the candidate weight matrix according to a set weight mapping table, to obtain the weight matrix corresponding to the coded block.

12. The video decoding method according to claim 1, wherein the reference weight derivation function is selected from the following functions: a linear function, a sigmoid function, a hyperbolic function, a trigonometric function, an exponential function, a polynomial function, and a piecewise function.

13. The video decoding method according to claim 1, wherein the reference weight derivation function is configured for indicating a mapping relationship table between a target distance and a reference weight, and the target distance is a distance between a sample point and a blending boundary; and
the mapping relationship table stores a mapping relationship between the target distance and the reference weight; and the reference weight in the mapping relationship table is generated according to the target distance and a preset function, or is generated according to the target distance and the preset function and then adjusted.

14. An electronic device, comprising:
one or more processors; and
a memory, configured to store one or more computer programs, the one or more processors executing the one or more computer programs, to cause the electronic device to implement a video decoding method including:
decoding a video bitstream to obtain bitstream information;
determining a reference weight derivation function used by a coded block according to the bitstream information;
calculating a reference weight corresponding to the coded block according to the reference weight derivation function;
determining, according to the reference weight, a weight matrix corresponding to the coded block; and
performing weighted prediction according to the weight matrix, to obtain a predicted value corresponding to the coded block.

15. The electronic device according to claim 14, wherein the determining a reference weight derivation function used by a coded block according to the bitstream information comprises at least one of the following manners:
determining, according to explicit index information in the bitstream information, the reference weight derivation function used by the coded block; and
determining, in an implicit manner according to the bitstream information, the reference weight derivation function used by the coded block.

16. The electronic device according to claim 14, wherein the bitstream information further comprises blending area length index information indicating a length of a blending area to which the reference weight derivation function is applicable; and the bitstream information is configured for determining, in an implicit manner, the length of the blending area to which the reference weight derivation function is applicable.

17. The electronic device according to claim 14, wherein the determining, according to the reference weight, a weight matrix corresponding to the coded block comprises:
calculating the weight matrix corresponding to the coded block according to the reference weight and a weight prediction angle used by the coded block; or
calculating a candidate weight matrix corresponding to the coded block according to the reference weight and the prediction angle used by the coded block, and performing mapping on the candidate weight matrix according to a set weight mapping table, to obtain the weight matrix corresponding to the coded block.

18. The electronic device according to claim 14, wherein the reference weight derivation function is selected from the following functions: a linear function, a sigmoid function, a hyperbolic function, a trigonometric function, an exponential function, a polynomial function, and a piecewise function.

19. The electronic device according to claim 14, wherein the reference weight derivation function is configured for indicating a mapping relationship table between a target distance and a reference weight, and the target distance is a distance between a sample point and a blending boundary; and
the mapping relationship table stores a mapping relationship between the target distance and the reference weight; and the reference weight in the mapping relationship table is generated according to the target distance and a preset function, or is generated according to the target distance and the preset function and then adjusted.

20. A non-transitory computer-readable medium storing a video bitstream that is decoded by a video encoding method, the video decoding method including:
decoding a video bitstream to obtain bitstream information;
determining a reference weight derivation function used by a coded block according to the bitstream information;
calculating a reference weight corresponding to the coded block according to the reference weight derivation function;
determining, according to the reference weight, a weight matrix corresponding to the coded block; and
performing weighted prediction according to the weight matrix, to obtain a predicted value corresponding to the coded block.
